(19) United States
(12) Patent Application Publication
(10) Pub. No.: US 2022/0067791 A1
(43) Pub. Date: Mar. 3, 2022

(54) METHOD AND APPARATUS FOR FORECAST SHAPED PACING IN ELECTRONIC ADVERTISING

(71) Applicant: Xandr Inc., New York, NY (US)

(72) Inventors: Aaron Martin, Arvada, CO (US); Craig Miller, Louisville, CO (US)

(73) Assignee: Xandr Inc., New York, NY (US)

(21) Appl. No.: 17/461,160

(22) Filed: Aug. 30, 2021

Related U.S. Application Data
(60) Provisional application No. 63/072,584, filed on Aug. 31, 2020.

(51) Int. Cl. G06Q 30/02

(52) U.S. Cl. CPC G06Q 30/0275; G06Q 30/0206; G06Q 30/0264; G06Q 30/0277

(57) ABSTRACT

Aspects of the subject disclosure may include, for example, identifying a first line item having a guaranteed delivery requirement; determining whether a capacity forecast is available for the first line item and whether a forecasted capacity for the first line item is greater than a capacity threshold; responsive to the capacity forecast being available for the first line item and the forecasted capacity being greater than the capacity threshold, accessing a forecast shape curve for the first line item, wherein generating the forecast shape curve comprises normalizing the forecasted capacity based on weighting for a particular time period of a day being equal to forecasted impressions for the particular time period divided by a sum of forecasted impressions over the day; and determining whether to sell an ad space in video content to the first line item pursuant to the guaranteed delivery requirement or to a second line item pursuant to a real-time bidding process. Other embodiments are disclosed.

### CROSS-REFERENCE TO RELATED APPLICATION(S)

The present application claims priority to U.S. Provisional Application No. 63/072,584, filed Aug. 31, 2020. All sections of the aforementioned application(s) and/or patent(s) are incorporated herein by reference in their entirety.

### FIELD OF THE DISCLOSURE

The subject disclosure relates to a method and apparatus for forecast shaped pacing in electronic advertising.

### BACKGROUND

Electronic advertising (e.g., online display advertising) delivers promotional messages to consumers by using visual advertisements (or “ads”), such as in web pages, Over-The-Top (OTT) video services, and so forth. For example, a publisher of a web page can insert an ad space in a web page where the ad space is a region of a web page (or other electronic document) where an advertisement can be placed. When the web page is displayed in a browser, a visual advertisement (e.g., a creative) of an advertiser can be dynamically retrieved from an ad server for the advertiser, and can be displayed in the ad space. Serving a creative (e.g., on a web page for displaying) is often referred to as an impression.

A collection of one or more ad spaces (e.g., on web pages served by web sites; in an ad pod of video content; and so forth) of a publisher can be referred to as ad space inventory. Publishers can sell their ad space inventories, such as to advertisers. Multiple publishers and multiple advertisers can participate in auctions in which selling and buying of ad space inventories take place. Auctions can be conducted by an ad network or ad exchange for a group of publishers and a group of advertisers.

Availability of inventory in electronic advertising typically changes throughout the day. One challenge of a naive pacing system that tries to pace a line item evenly across the hours of a day is that it becomes difficult to fulfill hourly delivery goals during the less-trafficked, lower inventory times of day. This lack of inventory can prevent a line item associated with a campaign or other advertising objective from meeting its pacing goals during those low-inventory times and therefore make it seem as if it is under-delivering. To account for this, one could speed up the pace. However, as more inventory becomes available later in the day, this increased pace will start to overspend.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system that provides forecast-shaped pacing in electronic advertising in accordance with various aspects described herein.

FIG. 2B depicts an illustrative embodiment of a method that provides forecast-shaped pacing in electronic advertising in accordance with various aspects described herein.

FIG. 2C shows a graphical representation of pacing weight over the hours of a day for a line item historical delivery and for an account-level average.

FIG. 2D shows a graphical representation of real-time guaranteed line item pacing implemented by forecasting, which gives pacing precision and yield increase or maximization on an impression-by-impression basis.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

FIG. 7 is a block diagram illustrating an example, non-limiting embodiment of a system that provides forecast-shaped pacing in electronic advertising in accordance with various aspects described herein.

FIG. 8 is a block diagram illustrating an example, non-limiting embodiment of ad placement in accordance with various aspects described herein to provide for electronic advertising.

FIG. 9 is a block diagram illustrating an example, non-limiting embodiment of a payload preamble in accordance with various aspects described herein to provide for electronic advertising across various inventory types.

FIG. 10 is a block diagram illustrating an example, non-limiting embodiment of a video payload in accordance with various aspects described herein to provide for electronic advertising across various inventory types.

FIG. 11 is a block diagram illustrating an example, non-limiting embodiment associated with unfilled time in accordance with various aspects described herein to provide for electronic advertising across various inventory types.

FIG. 12 is a block diagram illustrating an example, non-limiting embodiment associated with unfilled time in accordance with various aspects described herein to provide for electronic advertising across various inventory types.

FIG. 13 is a block diagram illustrating an example, non-limiting embodiment of a system in accordance with various aspects described herein to provide for electronic advertising across various inventory types.

FIG. 14 is a block diagram illustrating an example, non-limiting embodiment of a process in accordance with various aspects described herein to provide for electronic advertising across various inventory types.

FIG. 15 is a block diagram illustrating an example, non-limiting embodiment of a system in accordance with various aspects described herein to provide for electronic advertising across various inventory types.

FIGS. 16-17 are block diagrams illustrating example, non-limiting embodiments of systems in accordance with various aspects described herein to provide for electronic advertising across various inventory types.

### DETAILED DESCRIPTION

The subject disclosure describes, among other things, illustrative embodiments for providing forecast-shaped pacing in electronic advertising that delivers advertisements which can be referred to as impressions or creatives. In one or more embodiments, the forecasting can be performed in a number of different ways, such as determining ad space opportunities in one or more inventory types (e.g., website display, website video, Video-On-Demand (VOD), OTT video, addressable TV, Data-Driven Linear (DDL) TV, and so forth) for particular targets (e.g., audience having particular characteristic(s) and/or trait(s)). As an example, the forecast can determine the number of ad spaces that are associated with a particular target and that were available for sale for a particular day, hour, or other time period based on historical data covering a time window (e.g., going back one month, one quarter, one year, etc.) for that particular target. In one or more embodiments, line item(s) can be utilized to define financial relationships with an advertiser, including budget, revenue type, performance goals, bidding strategies, and/or inventory targeting.

In one or more embodiments, a forecast capacity for a line item that targets an audience with characteristic or trait X can be the number of ad spaces for media items (e.g., of a single inventory type or of multiple inventory types) that are associated with an audience having characteristic or trait X, which were available for sale for instance on a past Wednesday(s). In one or more embodiments, the forecast capacity can further be broken down to capacity or availability per hour or per another time period (e.g., every 15 minutes). In one or more embodiments, the targeting of an audience can be based on combinations of characteristics or traits (e.g., X, Y and Z) that identifies media items (e.g., of a single inventory type or of multiple inventory types) that are associated with an audience having the characteristics or traits X, Y and Z or having some of the characteristics or traits X, Y or Z.

In one or more embodiments, the forecasting can be utilized for pacing with respect to guaranteed line items so that the guaranteed delivery requirements can be fulfilled, while also allowing for yield improvement, such as delivering ad spaces to line items having higher bids (e.g., from programmatic or real-time bidding) for the particular ad spaces.

In one or more embodiments, forecast-shaped pacing can be applied across different inventory types. For example, forecast curves can be generated and applied so that impressions or creatives are movable between different inventory types rather than limiting the forecast-shaped pacing to a single inventory type. For instance, the forecast curve and yield analysis can enable a delivery of an impression or creative to be changed from video on a website to an ad space in an ad pod of an OTT movie or to an ad space in an ad pod for addressable or DDL TV video content. In another example, the forecast curve and yield analysis can enable a delivery of an impression or creative to be changed from video on a website (or from an ad space in an ad pod of an OTT movie) to an ad space in an ad pod for addressable or DDL TV video content.

In one or more embodiments, the determination to change delivery of the impression or creative from one inventory type to another inventory type can be based on the forecast-shaped pacing indicating: future ad space opportunities (e.g., in a same or different inventory type) for a particular line item, such as for the hour or for the day, based on the target associated with the particular line item; and/or other available line items for a particular ad space based on the target. In one or more embodiments, other factors can also be utilized in this process such as determining and analyzing forecast capacity for other available ad spaces based on the target in other inventory types. In one or more embodiments, additional factors to determine which impression or creative should be delivered can include determining or estimating yield associated with delivering to one of the particular line item or to one of the other available line items, including an analysis of bids associated with these line items, values associated with the ad space(s), and/or a priority level associated with the line items; and/or determining or estimating yield associated with filling the particular ad space or one of the other available ad spaces in the other inventory types based on the target with an impression from the particular line item, from one of the other available line items or from another impression, including an analysis of bids associated with these line items, values associated with the ad space(s), and/or a priority level associated with the line items.

In one or more embodiments, a forecast curve can be generated which allows for intelligent selections of line items including guaranteed and non-guaranteed line items in a single inventory type or across multiple inventory types, where the selections can take into account expected future bids, cost opportunities, future opportunities (e.g., for the remainder of the hour, day or other time period), and so forth. This allows an ad server (or other decision-making device) to select the ad delivery to increase yield (e.g., delivering to a higher RTB offer) while still seeking to satisfy any guaranteed line item requirements. This can include an ad server switching between guaranteed line items and non-guaranteed line items according to increasing yield (e.g., higher bids) while satisfying the guaranteed line item requirements according to predictions that guaranteed line items can be delivered in the future (e.g., in the remainder of the hour or day). In one or more embodiments, if proposed changes are indicated by a user (e.g., a frequency capping restriction to be applied and/or different traits targeted) then the system can indicate that a change to the curve has occurred and can further indicate whether the guaranteed requirements should be (e.g., prediction or estimation according to the forecast data) satisfied if the proposed changes are implemented. In one embodiment, the system can indicate hours or other time periods in which least valuable bids are expected and this information can be utilized to determine whether more guaranteed line items should be delivered during that particular time period.

In one or more embodiments, a system is provided that can understand or otherwise analyze how audiences (e.g., specific characteristics, traits or attributes) move throughout an ecosystem that inventory spans which can include various media types. The context for which audience is targeted and delivered, as well as, all of the possible audiences that could have been delivered to, can be significant to the ability to manage the inventory. In one or more embodiments, each ad server can execute a unique implementation of logic. Understanding and selecting the particular logic that the ad server will use at delivery time can be important. There are dynamic real time decisions and pre-delivery decisions performed by all ad servers and the exemplary system can have the ability to emulate the outcomes ahead of time to ensure or seek proper delivery. In one or more embodiments, after the inventory delivery emulation is understood or otherwise determined, there can be a distribution of spend to be accounted for. This can include an evaluation of the value of audience, value of inventory and/or comparison of competing inventory.

In one or more embodiments, emulation can be performed which is a reproduction of the function or action of a different computer or software systems (e.g., ad servers). The emulation can account for ad platform logic (e.g., Freewheel, Invidi, AppNexus Ad Server (Community) logic, and/or others) that can be enacted based on the configuration or scheduling within the ad server directly. This can utilize the ad server integrations that have already been built out, and can include: (1) overlap of audience based inventory within each ad server; and/or (2) overlap between ad server systems.

In one or more embodiments, the system can perform optimization (or improvement) in which the system provides a suggestion or recommendation for an optimized or improved approach that could be implemented to account for some or all of the overlapping inventory options and the value of the inventory. The system can analyze and determine higher or highest yielding solutions and decisions to be surfaced dynamically.

In one or more embodiments, the system can account for time differences in decision making such as linear inventory that may need up to a quarter to plan, addressable TV packages in targeted households that may need up to a week to plan, and/or digital and programmatic inventory which can be based on sub-second decisions. In one or more embodiments, the system can forecast across each of these distinct media types distinctly and can set pacing and yield optimization against each inventory type.

Addressable TV can be targeted by using a list of IDs that can be targeted on a set top box, where other criteria get stripped out of the ad server and limit the ad server's capabilities to perform frequency capping. In one or more of the exemplary embodiments, the system has the ability to understand the audiences at a holistic level and therefore what inventory is in competition against each other. The system can manage and analyze this data set and can offer recommendations to the ad server directly as to what would be more efficient with respect to the inventory. In one or more embodiments, the system can utilize this information to perform frequency capping which can include cross-inventory type and/or cross-device.

In one or more embodiments in DDL TV, data can be processed (e.g., from a service provider) that allows for an understanding of delivery and pacing, and which can provide unique feedback to the programmers. The forecasting capabilities can allow for optimization as to where in the schedule they should deliver in order to meet their goals for the campaign that is being evaluated and for others that need the same inventory.

In one or more embodiments, different logic can be applicable to different inventory types for forecasting and/or yield optimization. In one or more embodiments, yield optimization decisions with respect to TV implementation, such as addressable and DDL TV, may not need to be real-time decisions, since there can be a window until a schedule is finalized so decisions and changes can be made right up to the window deadline to maximize or otherwise improve yield. As an example, displacement techniques can be utilized as part of the yield optimization which can be based at least in part on forecast capacity. Displacement techniques, as well as other ad management techniques which can be used with one or more of the embodiments described herein are described in U.S. application Ser. No. 16/514,594 filed Jul. 17, 2019 and entitled “Method and Apparatus for Managing Allocations of Media Content in Electronic Segments”, the disclosure of which is hereby incorporated by reference herein.

In one or more embodiments, the forecast-shaped pacing allows for more informed decisions to be made as to which line item (e.g., including guaranteed line items) should receive delivery rather than other delivery techniques where pacing is based on a flat average number of impressions to be delivered each hour and/or other delivery techniques in which once the hourly threshold is met during that hour then the line item is no longer delivered and instead programmatic or real-time bidding can receive delivery for the rest of hour. In one or more embodiments, over an hour or other time period, the forecast-shaped pacing allows for switching between ad delivery to guaranteed line items and to non-guaranteed line items (e.g., Real-Time Bid (RTB) line items). This switching (which can be performed by various devices including an ad server) can be done based on various factors including one or more of: knowledge of potential capacity (in the same or a different inventory type) in the future (e.g., in future hours of the day, in the remainder of the hour, and so forth); yield or revenue thresholds; pCPM values; and so forth.

In one or more embodiments, delivery decisions can be made based on forecast capacity and knowledge of where value increases or decreases at different times of the day or hour (e.g., particular hours later in the day may be more valuable so deliver more guaranteed inventory earlier in day such that more programmatic or real-time bidding (with a higher yield) can be used during these more valuable hours).

In one embodiment, pacing can be applied throughout the lifetime of a line item to ensure that each line item meets its delivery goal in full and/or at a steady rate. Forecast-shaped pacing can be implemented to govern or otherwise manage daily pacing schedules for all or particular impression-based guaranteed line items on an electronic advertising platform. One or more embodiments can ensure or otherwise attempt to manage the line items, such that line items deliver at a rate that reflects the forecasted inventory available for the line item. In one embodiment, forecast-shaped pacing can provide a great amount of precision in delivery and can allow publishers to realize increased revenue from real time bidding through open dynamic allocation (e.g., allowing for competition in bidding for ad spaces including programmatic demand competing against direct deals).

In one embodiment, forecast-shaped pacing can set hourly (or other periodic) delivery goals for a guaranteed delivery line item according to an inventory forecast specific to that line item. For example, there may be less inventory available to a particular line item in the early morning hours (e.g., 2:00 AM) than in the afternoon. Forecast-shaped pacing can predict this variance and can therefore set a lower delivery goal for the line item at 2:00 AM than at 2:00 PM. In the afternoon, forecast-shaped pacing can set delivery goals to be higher because more supply is expected to be available than in the early morning. If inventory starts to drop again during the end of the day, the forecast-shaped pacing-governed line item will have less delivery scheduled accordingly.

In one or more embodiments, forecast-shaped pacing takes into account the variability of inventory throughout the day, setting hourly (or other periods such as 15 mins, 30 mins, and so forth) delivery goals that map to high-fidelity, line-item specific forecasts powered by a forecasting engine. In one embodiment, forecast-shaped pacing can be applied for all impression-based guaranteed delivery line items but not applied to line items with an exclusive delivery type.

Forecast-shaped pacing of the exemplary embodiments can positively impact both revenue from real-time bidding, as well as delivery accuracy or fulfillment. Forecast-shaped pacing can increase a publisher's yield through real-time bidding and open dynamic allocation. By pacing according to a forecasted supply curve, guarantees do not need to try as hard to deliver impressions when inventory is scarce (e.g., late night or early morning). In other words, a predicted CPM (pCPM) of a guaranteed line item can be significantly lower during these hours when there is less supply. This allows the publisher to take advantage of (i.e., deliver ads to) high CPMs from real-time bidding throughout all hours of the day.

As an example, in an analysis of data, it was seen that relaxed pressure during low-supply hours resulted in guaranteed line items using forecast-shaped pacing were able to bid a 25-35% lower pCPM on average than without forecast-shaped pacing. A lower pCPM means the opportunity cost of serving guaranteed line items is lower and publishers can capture more of their most valuable real-time bidding demand, which, in this analysis, translated to 15-20% more real-time bidding revenue on average.

In one or more embodiments, forecast-shaped pacing not only optimizes or improves how often guaranteed lines items deliver in full, but also improves how frequently they deliver through the last hour of the day. As an example, analysis of data showed that with forecast-shaped pacing, 90-95% of line items can deliver through the last hour of the day, a 15-20% improvement over pre-forecast shaped pacing mechanics. This improvement was the result of fewer adjustments having to be made throughout the day to meet delivery goals than were historically required.

In one or more embodiments, different techniques (which may or may not include forecast-shaped pacing) can be utilized at different times over a lifetime of a line item. For example, forecast-shaped pacing can be utilized up to the final day in the lifetime of the line item and a more aggressive pacing can be employed for the last day to ensure or seek full delivery.

In one or more embodiments, forecasting capacity (e.g., predicting or estimating what is available to sell) can be performed in a number of different ways. In one embodiment, forecasting can be performed on targets, rather than on products. Various factors can be utilized for forecasting the capacity of a target, which can include: consumption in a look back window; outliers (e.g., unexpected spikes and dips in the data); seasonality (e.g., seasonal models and determined differences in seasonal data); other adjustments (e.g., manual or automatic modifications for events that are not seasonal); and/or relationships between targets (e.g., target overlap).

In one embodiment, forecasting can be performed on targets across multiple inventory types. This can allow adjustments to be made to ad delivery by replacing one inventory type with another, such as delivering on a guaranteed line item in a first inventory type (e.g., at a first time period) so that a delivery can be performed on a second inventory type with a higher revenue (e.g., at the first time period or at a different time period). One or more embodiments allow determining a capacity to sell in different inventory types throughout a day such that selections of ad delivery can be made to further increase revenue or yield.

As an example, forecasting can include evaluating past consumption. Consumption in a look back window can be a first set of data considered when calculating capacity. For instance, the look back window can be configurable (e.g., by a client) but a typical value can be 42 days. In one or more embodiments, all data points can be reviewed (not just a sample set) and day of week patterns. As another example, forecasting can include spike detection and mitigation. For instance, accounting for seasonal patterns, if a day of week data point is an outlier it can be removed from consideration. How strictly the system determines outliers can be configurable. In one embodiment, a weighted average of included day of week data points can then be determined, with recent data weighted more heavily than older data points. In another embodiment, spike mitigation and detection can occur for a given target if there is a threshold amount of history (e.g., there is at least 5 weeks of history for that target). In another embodiment, new targets that have not accrued enough history can benefit from spike mitigation on overlapping products. As another example, forecasting can include applying seasonality. Seasonal models can be developed and implemented. For instance, a seasonal model can inform the system when a forecast needs to be altered from recent history. The spike-mitigated forecast can be increased or decreased based on a percent increase or decrease by day defined in the seasonal model. As another example, forecasting can include manual adjustments. For instance, when circumstances require that capacity is modified due to one-time events, clients can use manual adjustments to influence the forecast. In one or more embodiments, these adjustments can: entirely replace the forecasted value; change it relatively by percentage or by an absolute amount; and/or set a ceiling. In one or more embodiments, the system can ensure or seek proper proportions between overlapping targets be maintained.

In one or more embodiments, the selection of the forecast window can vary. For example, the selection can be a same day of a week in last few weeks or months (e.g., an average). In other embodiments, holidays or other events or anomalies can be taken into account when collecting the historical data, such as excluding historical data for a Wednesday which had an unusually high number of potential ad spaces available for sale because the Wednesday fell on a holiday.

In one embodiment, line item selection in a guaranteed ad serving environment or system can be determined by a weighting mechanism where delivery against budget, as opposed to price, is a primary factor impacting selection. Strictly basing line item selection on price can ignore the need to maintain even delivery of guarantees. In one embodiment, one, some or all bidders (e.g., a console application at a server) can provide in bid responses to a transaction bus a valuation (e.g., a priority CPM) that reflects the guaranteed line item's need for fulfillment. In one embodiment, whether received from a bidder, calculated by a transaction bus, and/or determined otherwise, a priority CPM for a particular line item can be determined based on various factors including pacing towards a goal. In one embodiment, the further a line item is from the goal for a particular defined interval, the higher the priority CPM can be. In one embodiment, during an auction for an impression to be served to an impression consumer, guaranteed line items can be evaluated based on their priority level, and those with the highest priority level can be evaluated first. In one embodiment, if no line item having a highest priority level is in need of the impression, line items in the next highest priority level can be evaluated, and so on. In one embodiment, guaranteed line items that have already met their budget goals for a particular defined interval of time can be ignored (e.g., no bid for the impression is entered). In one embodiment, a randomness factor can be applied to ensure that the same line item is not always selected within an interval where a priority CPM is static. Various other techniques can be utilized in other embodiments for managing guaranteed line item selection as is further described herein.

In one or more embodiments, the selection of a creative to fill an ad space can be done via a number of different techniques which can also include a combination of techniques such as through use of a unified platform including one or more of direct sales, open exchange, and/or private exchanges. The creative can be of various types including a visual or audio advertisement such as an image, an animation, a video clip, an audio clip, and so forth. As an example, certain auctions can be conducted that involve two parties: a seller who is offering inventory on an exchange and a buyer that targets that inventory. As another example, alone or in conjunction with the auctions, deal auctions (e.g., including deals that are provided via an SSP server and/or deals that are provided via the equipment of the entity managing the advertising exchange) can be conducted where a seller packages their own inventory into a deal object and offers preferential terms (e.g., pricing, priority, and/or creative attributes) to a specific buyer. As yet another example, alone or in conjunction with the auctions and/or the deal auctions, curated deal auctions can be conducted where a broker aggregates inventory across multiple sellers and offers that up to buyers. For instance in some curated deal auctions, the broker can augment the curated deals with other data, such as data collected by or otherwise obtained by the broker (e.g., a merchant website that collects sales history data for users and that operates as a broker to aggregate inventory across multiple sellers and offers that up to buyers while also providing collected data to facilitate the curated deals). Other data can also be provided (e.g., subject to opt-in or authorization of the end users) including content consumption history, search histories, and so forth. Other features of deals that can be implemented in conjunction with the exemplary embodiments are described in U.S. application Ser. No. 16/870,098 filed May 8, 2020 and entitled “Method and Apparatus for Managing Deals of Brokers in Electronic Advertising”, the disclosure of which is hereby incorporated by reference herein.

In one embodiment, for a line item targeting managed inventory, a line item's priority can be set (e.g., by a user or otherwise) to weight the line item against other direct line items within the user's account. In this example, the line item with the highest priority will win, even if a lower priority line item bids more. In one embodiment, a weight can be provided (by a user or otherwise) such that the weight is determinative of the creative rotation strategy for same-sized creatives managed at the line item level. Other embodiments are described in the subject disclosure.

One or more aspects of the subject disclosure is a device, comprising: a processing system including a processor; and a memory that stores executable instructions that, when executed by the processing system, facilitate performance of operations. The operations can include identifying a first line item having a guaranteed delivery requirement; determining whether a capacity forecast is available for the first line item and whether a forecasted capacity for the first line item is greater than a capacity threshold; and responsive to the capacity forecast being available for the first line item and the forecasted capacity being greater than the capacity threshold, determining whether the first line item is mid-flight or last-day. The operations can include responsive to the first line item being mid-flight, accessing a forecast shape curve for the first line item, where the generating the forecast shape curve comprises normalizing the forecasted capacity based on weighting for a particular hour being equal to forecasted impressions for the particular hour divided by a sum of forecasted impressions over a day. The operations can include determining whether to sell an ad space in video content, via an electronic ad delivery platform, to the first line item pursuant to the guaranteed delivery requirement or to a second line item pursuant to a real-time bidding process, where the determining whether to sell the ad space is based on applying the forecast shape curve on an hourly basis over the day to satisfy hourly delivery goals for the guaranteed delivery requirement of the first line item.

One or more aspects of the subject disclosure include a method including identifying, by a processing system including a processor, a first line item having a guaranteed delivery requirement. The method can include determining, by the processing system, whether a capacity forecast is available for the first line item and whether a forecasted capacity for the first line item is greater than a capacity threshold. The method can include, responsive to the capacity forecast being available for the first line item and the forecasted capacity being greater than the capacity threshold, accessing, by the processing system, a forecast shape curve for the first line item, where generating the forecast shape curve comprises normalizing the forecasted capacity based on weighting for a particular time period of a day being equal to forecasted impressions for the particular time period divided by a sum of forecasted impressions over the day. The method can include determining, by the processing system, whether to sell an ad space in video content, via an electronic ad delivery platform, to the first line item pursuant to the guaranteed delivery requirement or to a second line item pursuant to a real-time bidding process, wherein the determining whether to sell the ad space is based on applying the forecast shape curve over the day to satisfy delivery goals for the guaranteed delivery requirement of the first line item for each particular time period over the day.

One or more aspects of the subject disclosure include a machine-readable medium, comprising executable instructions that, when executed by a processing system including a processor, facilitate performance of operations. The operations can include generating a capacity forecast for each of a group of line items resulting in a group of capacity forecasts, wherein each of the group of line items includes a guaranteed delivery requirement, where each of the group of capacity forecasts are for an active day in a flight of a corresponding one of the group of line items, where the generating the forecast shape curve comprises normalizing a forecasted capacity based on weighting for a particular time period of the active day being equal to forecasted impressions for the particular time period divided by a sum of forecasted impressions over the active day. The operations can include identifying a first line item from the group of line items having a first guaranteed delivery requirement; and determining whether a first forecasted capacity for the first line item is greater than a capacity threshold. The operations can include, responsive to the first forecasted capacity being greater than the capacity threshold, accessing a first forecast shape curve for the first line item from among the group of capacity forecasts. The operations can include determining whether to sell an ad space of video content, via an electronic ad delivery platform, to the first line item pursuant to the first guaranteed delivery requirement or to a second line item pursuant to a real-time bidding process, where the determining whether to sell the ad space is based on applying the particular forecast shape curve over the active day to satisfy delivery goals for the first guaranteed delivery requirement of the first line item for each particular time period over the active day.

Pacing control techniques, viewability monitoring, prioritization of line items and/or other ad delivery management techniques which can be used with one or more of the embodiments described herein are described in U.S. application Ser. No. 16/037,621 filed Jul. 17, 2018 and entitled “Real-Time Data Processing Pipeline and Pacing Control System and Methods”, the disclosure of which is hereby incorporated by reference herein.

Control loop feedback, pacing control techniques, data management techniques, resource exhaustion management techniques, bidding management and control techniques and/or other ad delivery management techniques which can be used with one or more of the embodiments described herein are described in U.S. application Ser. No. 15/416,132 filed Jan. 26, 2017 and entitled “Systems and Methods for Real-Time Structured Object Data Aggregation and Control Loop Feedback”, the disclosure of which is hereby incorporated by reference herein.

Bidding management and control techniques, bid adjustment techniques, budget spending pacing control techniques, and/or other ad delivery management techniques which can be used with one or more of the embodiments described herein are described in U.S. application Ser. No. 14/561,615 filed Dec. 5, 2014 and entitled “Modulating Budget Spending Pace for Online Advertising Auction By Adjusting Bid Prices”, the disclosure of which is hereby incorporated by reference herein.

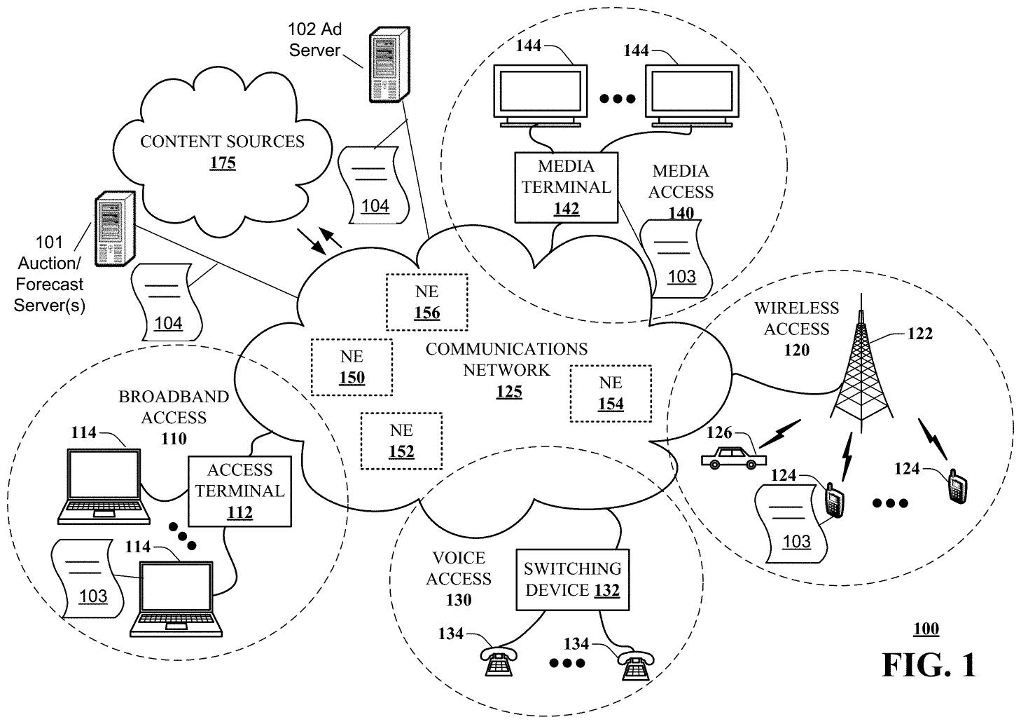

Referring now to FIG. 1, a block diagram is shown illustrating an example, non-limiting embodiment of a communications network 100 in accordance with various aspects described herein. For example, communications network 100 can facilitate in whole or in part forecast-shaped pacing for electronic advertising (in a single inventory type or in multiple inventory types). The forecast-shaped pacing can be utilized with respect to guaranteed delivery line items so that the guarantee is fulfilled while yield is also improved or optimized such as through selective delivery of line items via programmatic or real-time bidding. Pacing can be applied, such as throughout the lifetime of a line item, to attempt or ensure that each line item meets its delivery goal in full. Forecast-shaped pacing can be utilized to govern daily/hourly/other time period pacing schedules for all impression-based guaranteed line items on the platform to attempt or ensure line items deliver at a rate that reeds the forecasted inventory available for the line item. The computing system that performs all or some of these functions can be various devices or combinations of devices including auction/forecast server(s) 101 and/or ad server 102 which can be in communication with the communications network 125.

FIG. 1 illustrates the ad server 102 in communication with the communications network 125, where the ad server can facilitate the process, including delivering of a particular creative of the winning bidder to the end user device presenting the media content which includes the ad space that is being sold. However, one, some or all of the functions described herein can be performed by the server(s) 101, the ad server 102, another server not shown, or any combination thereof, including in a virtual computing device or a distributed processing environment. In one or more embodiments, forecast data (such as forecast capacity for one or more line items broken down by a particular time period such as per hour of a day) can be collected and communicated (e.g., to the ad server 102) to facilitate pacing and decision making with respect to delivery to line items (which can include guaranteed line items and/or non-guaranteed line items). The forecasting can be performed in a number of different ways, such as based on predicting ad space opportunities, according to historical data associated with particular target(s), including an analysis of historical delivery of any impressions to particular targets over particular time periods (rather than historical data based on a particular product or particular impression).

One, some or all of the functions described herein can also be performed in a client-side implementation (e.g., utilizing a script executed by the end user device, ad server 102, or any combination thereof) and/or a server-side implementation (e.g., via server(s) 101, ad server 102, another server not shown, or any combination thereof). In one or more embodiments, a CSAI implementation for managing digital advertising can be utilized via a code or script 103 (e.g., a javascript) operating on or otherwise being executed by an end user device that will be rendering the content and ad space. The script 103 can perform various functions including one or more of prebidding, ad insertion, communicating with various devices (e.g., ad server 102 and/or server(s) 101) and so forth. In this example, the script 103 can be utilized in conjunction with one or more of the functions described herein where curated deals are analyzed to determine winning bidders.

Data 104 can be communicated, collected, generated and/or analyzed in order to provide forecast-shaped pacing including for guaranteed line items in various inventory types. In one or more embodiments, a normalized forecasted capacity can provide a starting point for hourly (or other periods) weights. Adjustment factors can be applied to these weights to account for various circumstances such as (1) day-parting and/or (2) whether the line item is mid-flight or one-day or last-day. For example, the adjustment factors can be determined using various criterion or a combination of criteria including historical data, simulations, controlled testing with active or reinforcement learning, such as based on small batches of line items that have been stratified into test and control groups. In one or more embodiments, forecast-shaped pacing can be utilized as an algorithm and can include or otherwise account for programmatic guaranteed line items, pCPM calculations and/or guaranteed line item selection. In one embodiment, once weights are generated in a forecast curve, a budget-pacing controller can then implement the pacing. For instance, a production job can write adjusted weights, which are computed by the forecast pacing algorithm, to the budget-pacing controller, which can be a production application that implements the pacing such as through use of a PID controller. In one or more embodiments, a pCPM calculation can be made which is based on bidding history in bid landscape logs. This example can include a determination of weights for guaranteed line item selection between competing lines, which can be done based on budget, forecasted capacity and/or current fill.

In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

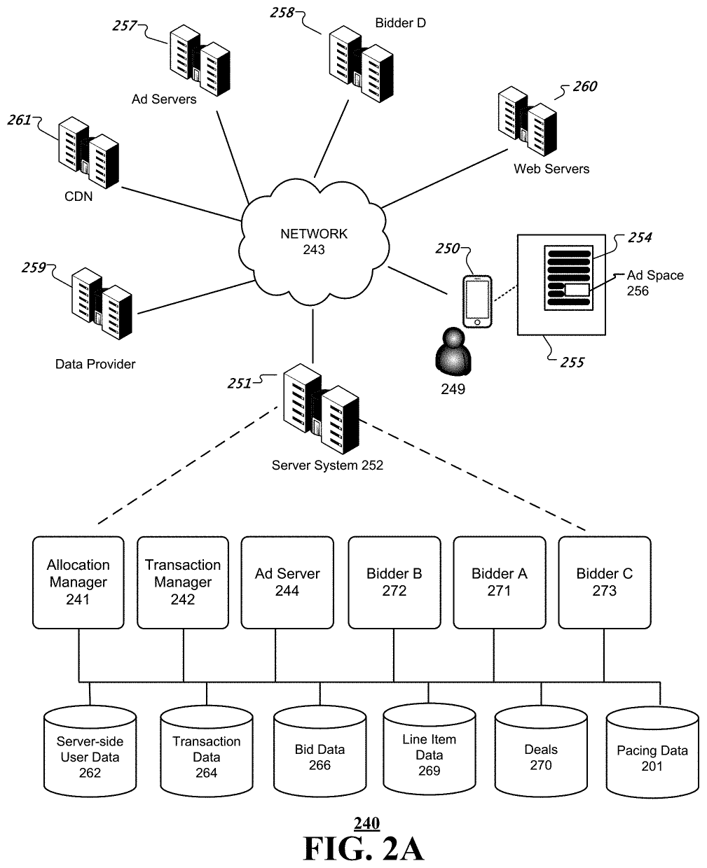

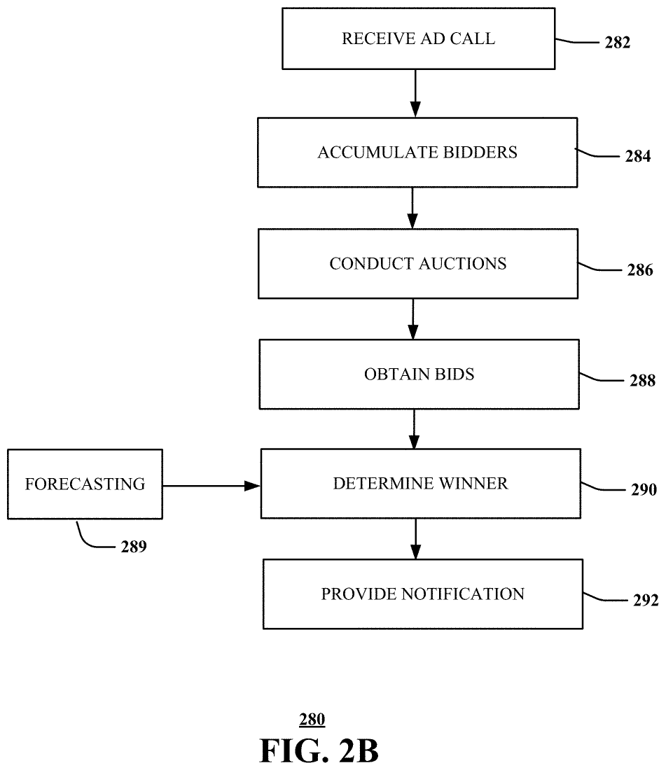

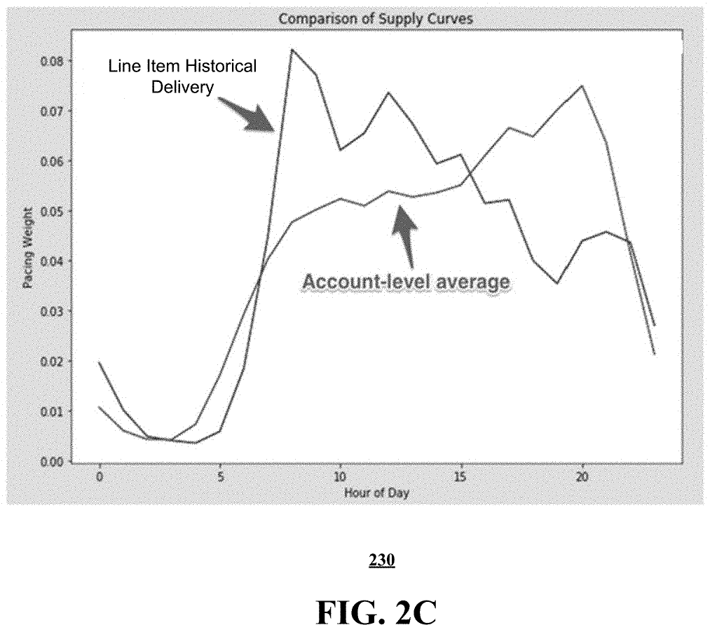

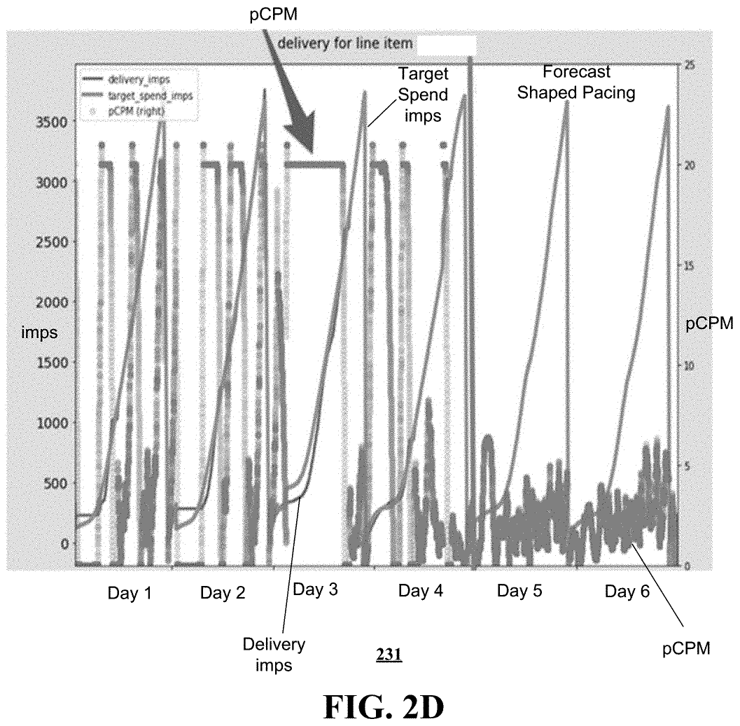

Referring now to FIG. 2A, a block diagram is shown illustrating an example, non-limiting embodiment of a system 240 in accordance with various aspects described herein to provide for electronic advertising which can include forecast-shaped pacing. Various devices and combinations thereof can be utilized to implement the electronic advertising including employing one or more of the devices or functions of system 100 of FIG. 1. System 240 enables management of electronic advertising in a number of different ways which can include applying forecast-shaped pacing to various inventory types and can be applied to guaranteed line items.

In one or more embodiments, system 240 can utilize pacing data 201. For example, the pacing data 201 can be utilized to implement forecast-shaped pacing so that more informed decisions are made as to which line item (e.g., including guaranteed line items) should receive delivery rather than other delivery techniques such as if is based on a flat average number of impressions to be delivered each hour. In one or more embodiments, delivery decisions can be made based on knowledge of where value increases or decreases at different times of the day or hour such that more programmatic or real-time bidding (with a higher yield) can be used during these more valuable hours.

The pacing can be applied throughout the lifetime of a line item or at different periods. In one embodiment, forecast-shaped pacing can be applied across different inventory types including websites, video, and so forth. In one embodiment, the pacing data 201 includes or otherwise allows for generating a forecasted supply curve, so that guaranteed line items do not need to try as hard to deliver impressions when inventory is scarce (e.g., late night or early morning). In other words, a pCPM of a guaranteed line item can be significantly lower during these hours when there is less supply. This allows the publisher to take advantage of high CPMs from real-time bidding throughout all hours of the day.

In one embodiment, a server system 252 manages allocating of ad space inventory with respect to various types of content including web pages, video games, videos and so forth. In some embodiments, the server system 252 can provide various functions for electronic advertising including real-time ad space data packaging and auctions. The server system 252 can include hardware components, software components, databases, components executing on the same or on different individual data processing apparatus, and so forth, which can be deployed at one or more data centers 251 in one or more geographic locations. Various configurations of the server system 252 can be utilized to perform one or more of the functions described herein (including functions described with other embodiments). For example, the server system 252 can include one, some, or all of: an allocation manager 241, a transaction manager 242, an ad server 244, and one or more bidders (e.g., bidder A 271, bidder B 272, and bidder C 273). The server system 252 can also perform load balancing and/or provide security, such as managing traffic within a single data center or between multiple data centers, and/or managing data protection and access privilege for tenants served by the data centers 251. In one or more embodiments, the server system 252 can also include or have access to memory resources (e.g., distributed and/or centralized physical storage systems) including one or more databases such as a server-side user data database 262, transaction data database 264, bid data database 266, deals database 270 and/or line item database 269.

In one or more embodiments, a broker can generate a curated deal where the broker aggregates inventory across multiple sellers and offers that up to buyers. The broker can create (e.g., through an API or a web page provided by the server system 252) a curated deal and store the curated deal, such as in the line item database 269, the deal database 270 and/or another database. A curated deal or curation deal line item that has been stored can include various information including one or more of identification of a buyer(s) and/or seller(s), terms of any agreements with the buyer(s) and/or seller(s), targeting information, seller inventory (e.g., publishers, sites, sections, pages, ad units, and so forth), audiences (e.g., behavioral, demographic, and so forth), user geography, user technographics (e.g., devices, operating systems, and so forth), content categories, user frequency and recency restrictions, other custom information the seller knows about the user or inventory, and so forth.

In one or more embodiments, a seller can negotiate with a buyer and can reach an agreement on pricing or other terms on an ad space inventory of the seller. The seller can create (e.g., through an API or a web page provided by the server system 252) a deal (e.g., implemented as a data object) for the agreement and store the deal in the deals database 270. A deal stored in the deals database 270 can include one or more of an identifier for the seller, an identifier for a buyer, an identifier for the deal, an identifier of an ad space inventory of the seller, and a floor price for an ad space in the ad space inventory. For instance in one embodiment, the floor price can specify a minimum bid price for the buyer. In one embodiment, the deal can also include flight dates (e.g., start and ending dates for the deal), one or more user target segments, and/or an auction type. The auction type can specify whether the deal is private or public. In one embodiment for the private auction type, auctions for ad spaces of the deal can be open only to buyers having agreements with the seller on the deal's corresponding ad space inventory. In another embodiment for the public auction type, auctions for ad spaces of the deal can be open to every eligible buyer and not limited to buyers having agreements with the seller on the deal's corresponding ad space inventory.

In one embodiment, a graphical user interface 254 of a software application 255 executing on client device 250 of a user 249 can include an ad space 256 and a corresponding ad tag. The application 255 can be a web browser application, or a software application such as a game application or a maps application. The application 255 can retrieve content presented via the user interface 254 (e.g., a web page) through one or more data communication networks 243 (e.g., the Internet) from, for example, web servers 260 of a publisher, although various sources of content can be utilized. For instance, a web page displayed in a browser window of a web browser (e.g., executing on a personal computer or a media processor) can include an ad space on the web page and a corresponding ad tag. The client device 250 can be various types of devices including a mobile phone, a smartphone, a smart watch, a tablet computer, a personal computer (e.g., laptop computer, desktop computer, etc.), a game console, a vehicle media system or any other end user device. The example of system 240 illustrates an ad space on a web page, however, the system (including forecast-shaped pacing techniques) can be applied across various inventory types and combinations of those types, including video.

In one embodiment, the ad tag can include a Uniform Resource Locator (URL)) address (or other addressing indicia) of a device or system from which an ad will be requested (e.g., a URL for the server system 252), statements (e.g., Hypertext Markup Language (HTML) statements) for retrieving and displaying a creative, and/or instructions (e.g., JavaScript instructions) for retrieving and displaying a creative (e.g., displaying the creative in a frame, for example a 160 pixel×600 pixel iframe). In one embodiment, executing the ad tag can cause the application 255 to send (e.g., through the network 243) an ad request or ad call to the addressed device or system (e.g., to server system 252). In some implementations, the application 255 sends an ad request to the server system 252 via another advertising server system such as an ad exchange. In one embodiment, the ad request can include information about the available ad space 256 (e.g., a size for the ad space, an identifier for the publisher), user information (e.g., an identifier of the user 249, data describing the user 249, an Internet Protocol or IP address of the device 250, etc.), and/or system information (e.g., types of the browser and the client device). In one embodiment, the ad request can be composed in JavaScript Object Notation (JSON) or Extensible Markup Language (XML) format and transmitted to the server system 252 using Hypertext Transfer Protocol (HTTP) protocol (e.g., using HTTP POST request method). Although, other ad request formats and transmission methods can be utilized.

In one embodiment, the allocation manager 241 or other components of the server system 252 can attempt to allocate portions of ad space inventory to buyers. A buyer can be an advertiser (e.g., a credit card company, a sportswear company), an ad network, an ad exchange, an advertising agency, or another entity. A seller can be a publisher (e.g., newspaper or social network), an online streaming or gaming service, an ad exchange, an ad network or another entity. In one embodiment, a broker can be an entity that is distinct from the buyers and sellers or can be one of the sellers.

In one embodiment, the allocation manager 241 or other components of the server system 252 can process ad requests, allocate ad space inventory referenced by the ad requests to buyers (e.g., based on agreements between brokers, buyers and/or the seller of the ad space inventory, based on the results of auctions, and so forth), send relevant information to advertisers, return creatives to the browsers or other applications, maintain or otherwise monitor billing and usage data for advertisers and publishers, and/or enforce policies or business rules including quality standards, yield optimization policy, competitive separation, brand safety, frequency capping, and so forth.

In one embodiment, a seller can negotiate an agreement with a buyer on pricing or other terms for an ad campaign. The seller and/or the buyer can create (e.g., through an API or a web page provided by the server system 252) one or more line items (e.g., implemented as data objects) representing the terms of the agreement and store the line items in the line item data database 269. As another example, a buyer can use pre-bidding techniques to place bids on an instance of ad space. For instance, a client-side auction can be conducted such as before the application 255 sends the ad request to the server system 252, although other timing could also be utilized, as well as other pre-bidding techniques including a server-side auction. The seller and/or bidders can create (e.g., through an API or a web page provided by the server system 252) one or more line items (e.g., implemented as data objects) representing the bidders' pre-bids. In these examples, a line item's parameters can include, without limitation, an identifier of a seller, an identifier of a buyer, identifiers of one or more ad spaces from the seller's ad space inventory, ad tags of one or creatives from the buyer's ad campaign, flight dates (e.g., start and ending dates for the ad campaign), one or more user target segments, and/or a price for filling an instance of an ad space with a creative from the buyer's ad campaign. In one embodiment, for line items associated with ad campaigns, the value of the price parameter can be a static price based on the terms of the agreement between the buyer and seller. In one embodiment, for line items associated with pre-bids, the price can be determined based on the buyer's pre-bid.

In one embodiment, the allocation manager 241 or other component of the server system 252 can compare data associated with the instance of the ad space to the parameters of the line items in the line item data database 269 and where more than one line item matches the ad request, the allocation manager 241 can apply prioritization rules to determine winning bids or deals.

Various data can be utilized as part of the management and bid selection process, including data associated with the instance of the ad space 256 such as user segment data and/or user behavioral data. For example, user segment data can include demographic information, such as one or more of age, gender, location, school, and occupation. Other user segment data are possible. User behavioral data can include data associated with a user's online activities, for example, that the user put an item in a shopping cart, the user searched for an item, the user visited an online store (e.g., within a particular time period) that sells the item, and/or a frequency the user searched for the item. Other user behavioral data are possible. Data associated with the instance of the ad space 256 can include contextual data. In one embodiment, contextual data can include the type of the user interface 254 (e.g., a home page, a user interface of a game application, etc.), structure of the user interface 254 (e.g., a number of ads on the user interface 254), content of the user interface 254 (e.g., game, finance, sports, travel, content not suitable for children), an identifier of the ad space, the dimensions of the ad space, and/or timing data (e.g., the current month, day of the week, date, and/or time). Other contextual data are possible.

In one embodiment, user segment data (e.g., demographic information) can be provided by a user to a publisher when the user accesses websites or applications published by the publisher. Some user segment data (e.g., location) can be determined by data associated with the user's client device (e.g., client device 250), such as an Internet Protocol (IP) address associated with the client device. User behavioral data can be collected in various ways such as by an application (e.g., application 255) executed on a user's client device (e.g., client device 250). Contextual data can be determined in a number of different ways such as by analyzing content (e.g., words, semantics) presented in the user interface, transmitted to the server system 252 with the ad request, or obtained using any other suitable technique. Other techniques can be utilized for gathering various data that facilitates decisions by the buyers.

A buyer, seller and/or broker can acquire data associated with an ad space from the ad space's publisher and/or from a data provider (e.g., Proximic of Palo Alto, Calif.). In one or more embodiments, the buyer, seller and/or broker can store user data in the server-side user data database 262. For instance, the buyer can store in the server-side user data database 262 mappings between user identifiers and user segments.

In some embodiments, the allocation manager 241 or other component of the server system 252 can enforce or otherwise implement allocation policies designed to enhance the seller's revenue while also adhering to the terms of the seller's ad campaign agreements. For example, when an ad campaign line item and a pre-bid line item match an ad request, and the pre-bid line item's price for the ad space exceeds the ad campaign line item's price, the allocation manager 241 can allocate the ad space to the pre-bidder, rather than the ad campaign partner. On the other hand, if allocating the ad space to the pre-bidder would jeopardize the system's ability to meet the terms of its agreement with the ad campaign partner, the allocation manager 241 can allocate the ad space to the ad campaign partner, even though the ad campaign line item's price is lower than the pre-bid line item's price.

The server system 252 (e.g., via the allocation manager 241) can select one of the matching line items to fill the ad space based on any suitable information, including, without limitation, forecast-shaped pacing information, bid prices, curated deal terms, prioritization rules, line items' parameters (e.g., the price parameters), terms of ad campaign agreements, and/or status of current ad campaigns (e.g., current pacing of the ad campaign). In one or more embodiments, line items can include priority parameters that represent a priority rank or a priority tier of the line item. In one embodiment, the allocation manager 241 or other component of the server system 252 can select a line item to fill an ad space based, at least in part, on the priority parameters of the matching line items.

In one or more embodiments, a client device 250 can conduct a client-side auction before sending the ad request to the allocation manager 241. During the client-side auction, the client device 250 can receive one or more pre-bids for the ad space from one or more pre-bidding partners. The client device 250 can send the pre-bids to the allocation manager 241 such as by adding data indicative of the pre-bids to a URL (e.g., a URL that the software application 255 calls to send an ad request to server system 252), for example, the pre-bidder identifier and pre-bid value can be encoded as key-value pairs in the URL's query string. After the software application 255 calls the URL to send the ad request to the server system 252, the allocation manager 241 or other component of the server system 252 can parse the URL's query string to determine the pre-bidder identifier and the pre-bid value for each pre-bid.

In one or more embodiments, the allocation manager 241 or other component of the server system 252 can also receive creative data from client device 250 for the pre-bids such as creative identifier or URL being added to the query string. In one or more embodiments, the server system 252 can allocate ad space to a buyer without conducting a server-side auction.

In one or more embodiments, the transaction manager 242 or other component of the server system 252 can implement an auction system that facilitates transactional aspects of ad space inventory and impression trading involving brokers, buyers and sellers. For example, the transaction manager 242 can process requests (e.g., deal or RTB requests) received from the allocation manager 241, conduct auctions (e.g., on behalf of sellers and/or brokers), return creatives to the allocation manager 241 or the software application 255 executing on the client device 250, and/or return auction-result data, for example. The transaction manager 242 can store in the transaction data database 264 various transaction information for each ad space that is transacted by the transaction manager 242 or other components of the server system 252.

In one or more embodiments, a bidder system or bidder (e.g., bidder A 271) can perform bidding operations on behalf of a buyer. For example, the bidder can receive bid-specific information (e.g., one or more of maximum bid price, target user areas or segments, start and end dates, budget) as input and can generate a bid for a particular instance of an ad space inventory. As another example, a buyer can set up (e.g., through an API or web pages provided by the server system 252) a campaign targeting an ad space inventory with a set of bid-specific information for the ad space inventory and store the bid-specific information in bid data database 266. In one or more embodiments, a bidder can operate outside of or otherwise remote from the server system 252, such as bidder D 258. Continuing with this example, the transaction manager 242 can generate a bid request including information about the ad space, the user, and so forth, and can send the bid request to multiple bidders such as bidder A 271, bidder B 272, and bidder C 273, as well as via the networks 243 to servers of other bidders (e.g., bidder D 258). These bid requests (which can be encoded or compressed) can be composed in various formats such as JSON format and sent to bidders utilizing various protocols such as HTTP POST. The winning bid price can be the highest bid price, a second highest bid price of the auction as determined by Vickrey auction or other second-price auction mechanisms or determined via another winning bidding mechanism or policy.

In one or more embodiments, each bidder can determine an appropriate bid based on its own requirements (e.g., budget, targets in placements, and so forth) and can selectively submit a bid response such as including a bid price and/or an identifier of a creative to be served to the transaction manager 242 or other component of server system 252. In one or more embodiments, the transaction manager 242 or other component of server system 252 can determine a winning bid (e.g., a highest bid) among bid responses received within a specified time period (e.g., 100 milliseconds although other time limits can be applied). In one or more embodiments, the transaction manager 242 or other component of server system 252 can provide a creative associated with the winning bid or identification information (e.g., a URL) of the winning bid creative, such as via the allocation manager 241, which can cause the application 255 to display the creative in the ad space in the user interface 254. In one embodiment, the client device 250 can obtain the creative for the winning bid based on a received URL which enables retrieving the creative from another source, such as an ad server (e.g., ad server 244, or ad servers 257 external to the server system 252), or from servers of a content distribution network (CDN) 261. In one or more embodiments for ad campaign line items, the creatives or URLs of the creatives associated with the line items can be provided (e.g., by the buyer) when the line items are created (e.g., through an API or a web page provided by the server system 252). In one or more embodiments for pre-bid line items, the creatives can be provided by the pre-bidders along with their pre-bids.

In one or more embodiments, the ad server 244 can serve creatives to web browsers or other applications. In one or more embodiments, the ad server 244 can make decisions about which creatives to serve, and/or can monitor clicks or other user interactions with creatives. In one or more embodiments, the allocation manager 241 can store in the transaction data database 264 transaction information such as one or more of an identifier of the creative served to the ad space, an identifier of the broker, an identifier of the buyer, the user's identifier, the price of the ad space, an identifier of the ad space, an identifier of the seller of the ad space, and/or a time stamp. Other transaction information of a transaction can also be monitored and stored.

In one or more embodiments, publishers or sellers can allocate portions of their ad space inventory to buyers (e.g., advertisers or ad networks) for the buyers' ad campaigns (e.g., direct ad campaigns or programmatic ad campaigns) through offline agreements. For example, different percentages of the ad space inventory on a landing page of a website during a specified time period (e.g., a week or a month) can be allocated to different advertisers for each of their ad campaigns. These agreements can include a number of terms such as one or more of payment model and/or pricing for the ad space inventory, a desired pacing of the ad campaign (e.g., the time rate at which the publisher's ad spaces are allocated to the ad campaign), targeting parameters (e.g., preferences or limits on which instances of ad space inventory can be allocated to an ad campaign, based on data associated with the ad space inventory), priority of the ad campaign relative to contemporaneous ad campaigns on the publisher's site, and so forth.

In one or more embodiments, these agreements can be implemented and enforced by an allocation manager associated with (e.g., executing on) the publisher's ad server. In one embodiment to implement and enforce the terms of such agreements, the allocation manager can utilize line items and prioritization rules. When a request to fill an available ad space is received, the allocation manager can compare characteristics of the ad space to the parameters of line items representing the publisher's agreements with buyers. If more than one line item matches the ad request (indicating that more than one creative or ad campaign may be eligible to fill the ad space), the allocation manager can apply the prioritization rules and/or pacing criteria to determine which ad campaign or creative fills the ad space.

In one or more embodiments, line items are used to allocate a seller's ad space inventory among buyers in ways that are consistent with the terms of agreements between the seller and the buyers, including terms relating to targeting, pacing, prioritization, number of impressions, and budget constraints. Line items can be implemented or generated in advance of starting an ad campaign, such as where values of parameters of line items (e.g., the values of price and/or prioritization parameters) are set by programmers prior to initiating the ad campaign.

In one or more embodiments, system 240 can enable publishers to make some ad space inventory available to real-time bidders via server-side auctions. In one embodiment, if a publisher's allocation manager determines that no line items match an ad request, the allocation manager can forward the request to an ad exchange, which can offer the ad space to bidders in a server-side auction. In this example, the ad space can then be allocated to the winning bidder, and the system can serve a creative provided by the winning bidder to fill the ad space.

In one or more embodiments, system 240 can enable publishers to implement pre-bidding which can be client-side and/or server-side auctions (for example which take place prior to allocating ad space inventory to the ad campaigns of the publishers' direct or programmatic partners). In one embodiment, when an instance of an ad space is available to fill (e.g., when a browser begins to load a web page with an ad space), a system can initiate an auction by requesting bids from pre-bidding partners. For example, auction data describing the results of the auction (e.g., the identity, bid price, and creative of the winning bidder, or the identities, bid prices, and creatives of multiple bidders) can be provided to the allocation manager, which uses the auction data to determine how to allocate the ad space.

In one embodiment, when a bid for an ad space is received from a pre-bid partner, the allocation manager can search for a line item with a buyer identity parameter that matches the identity of the pre-bid partner and a price (or price range) parameter that matches the value of the partner's bid.

FIG. 2B depicts an illustrative embodiment of a method 280 in accordance with various aspects described herein which allow for forecast shaped pacing in electronic ad delivery. Method 280 can be performed by various devices and/or combinations of devices described herein including the auction server 101 and/or the ad server 102 of FIG. 1; and/or the server system 252 of FIG. 2B. At 282, an ad call can be received by a processing system. For example, the ad call can be associated with an ad space available in media content that is being presented at an end user device. The media content can be various types of content including a web page, a video game, a video, connected TV, Video-on-demand, Over-The-Top content, long form video and so forth.

At 284, the processing system can identify or otherwise discover a group of bidders (or buyers) from among a plurality of bidders (or buyers). This discovery process can be performed in a number of different ways. For example, the identifying can be based on an analysis of seller's line items, seller deals, and/or curated deals, which are created and stored so as to be accessible when the ad call is received.

At 286, the processing system (or another device) can conduct auctions with the group of discovered bidders, which can include one or more curated deal auctions in which one or more brokers aggregates curated deal inventory across a plurality of sellers including the seller, and where the curated deal inventory includes the ad space. At 288, the processing system can obtain bids from the auctions.

At 289, forecast-shaped pacing can be applied as part of the process to determine ad delivery in conjunction with 290 where the processing system can determine a winning bid from among the bids. The analysis of the bids and the determining of the winning bid can be performed in a number of different ways, including ranking bids based on price, priority or other factors. At 292, various types of notification(s) can be provided by the processing system based on the winning bid. For example, an ad server and/or the end user device can be provided with the creative or an identification of the winning bid to enable the end user device to render the creative associated with the winning bid in the ad space.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In one or more embodiments, forecast-shaped pacing can be applied to all or some line items. For example, the forecast-shaped pacing can be applied to all guaranteed line items or a subset of them. In one embodiment, the selection of the line items can be done periodically, such as selecting all guaranteed line items that are active the next day. In one embodiment once selected, an API endpoint can obtain a next-day capacity forecast. For example, this can be a batch API that allows obtaining forecasts for a set of lines for a given member and time-zone, such as via a POST request. The data can be centrally located or can be distributed where particular servers that are to be queried are determined programmatically. In one embodiment, a forecast ingester application can execute queries in batches (e.g., of three hundred lines) and with parallel threads (e.g., two). In one embodiment, a forecast-shaped supply curve can be calculated from the capacity obtained using the API. The algorithm used to calculate the curve can depend on timing associated with a line item, such as whether the line item is mid-flight or is the last-day of flight (or a single-day line).

In one embodiment, under certain circumstances, if the following conditions are seen in the forecasted capacity, a network supply curve can be applied rather than a forecasted capacity: forecast capacity is all 0 or no forecast is received for the line item; total forecast capacity for all 24 hours is less than a minimum threshold (e.g., 100 impressions); and/or there are missing hours in the forecast (e.g., the API did not provide a forecast for all 24 hours). In one embodiment, the network supply curve can be a static curve that has been determined from historical averages by member and time-zone. In another embodiment, the same curve can be applied globally for all line items.

As an example, a network supply curve can consist of the following weights: [0.0167, 0.0133, 0.0121, 0.0125, 0.0157, 0.0233, 0.0318, 0.0405, 0.0476, 0.0500, 0.0522, 0.0495, 0.0509, 0.0512, 0.0523, 0.0526, 0.0567, 0.0599, 0.0592, 0.0626, 0.0658, 0.0569, 0.0400, 0.0267]. In another embodiment, for one-day or last-day line items a different network supply curve can be utilized with an accelerated first hour: [0.2959, 0.0622, 0.0593, 0.0565, 0.0536, 0.0507, 0.0478, 0.0450, 0.0421, 0.0392, 0.0363, 0.0334, 0.0306, 0.0277, 0.0248, 0.0219, 0.0191, 0.0162, 0.0133, 0.0104, 0.0076, 0.0047, 0.0017, 0.0000].

In one embodiment, supply-curves, whether forecast-shaped or network and mid-flight or one-day/last-day, can be further reshaped if the line item has dayparting enabled as explained below. For mid-flight line items with no day-parting, the forecast shaped curve can be calculated by normalizing the forecasted capacity (i.e., the weights for any given hour is the forecasted impressions for that hour divided by the sum of forecasted impressions for the entire day.) For one-day/last-day line items, the hourly weights can be calculated as described above based on the normalized forecasted capacity by hour. Transformations can then be applied. For example, weight in the first hour can be increased with non-zero weights by 0.02; weight can be reduced by 0.01 for 3 hours prior to the last hour with non-zero weights (clipping at 0.0); weights can be renormalized so they add up to 1.0.

In one embodiment, an acceleration can be applied which depends on the bfc_ratio (budget to forecasted capacity ratio) which is defined as:

$$bfc\_ratio = \frac{budget * 1.0}{( fc\_imps \_sum + 1 )}$$

In this example, the budget is the daily_budget for the line item and fc_imps_sum is the sum of the forecasted impression capacity. The acceleration applied for the various bfc_ratio ranges can be as follows:

| bfc_ratio range | accleration |
|---|---|
| <=0.2 | 0.075 |
| 0.2 < x <= 0.6 | 0.09 |
| 0.6 < x <= 1.0 | 0.12 |
| >1.0 | 0.3 |

In this example, the acceleration parameters were selected to balance both full and even delivery. The acceleration factor can be applied to each non-zero weight, clipping when the sum of weights reaches 1.0 and the weights can be renormalized.

End hour corrections can also be performed. For example, for all hours starting with the last hour with non-zero weights to the last hour of day, a weight of 0.01 can be added and then renormalization performed.

In one or more embodiments where dayparting is being implemented, a line item can have dayparting such as at the level of a day or hour. For example, if an entire day is dayparted out then the last day logic can take this into account. For instance, if the last day of a campaign is the 31st of October but this is a Sunday and per the targeting expression, the line item is not intended to deliver on weekends, then the effective last day is Friday the 29th and any/all last day corrections can be applied to that day.

In another embodiment, if specific hours of the day are dayparted out and it is the last day of the campaign, then an aggressive acceleration of the delivery can be employed so that the campaign delivers in full. For instance, the supply curve can be adjusted based on the number of non-dayparted hours and whether the dayparting happens closer to the end of day.

As an example, supply curves can be generated daily utilizing multiple threads as follows:
1. Identify guaranteed line items active the next day.
2. Pull capacity forecast for these line items and write this to a vertica table.
3. Calculate a supply curve to write for the line items (based on whether a valid forecast is available, mid-flight/one-day/last-day line, whether dayparting is applicable).
4. Apply supply curve for the line item by writing it to a budget pacing web server and also saving this supply curve in the vertica table.
5. Write out job metrics to web application (e.g., Grafana or other visualization web application).
Steps 2-4 can occur in multiple loops (e.g., over member, time-zone and in batches such as of 300 line items).

In one embodiment, the supply curve can be written via a PUT request. For example, this can be done one-line at a time and the curve can be written for a day of week. In one embodiment if a curve is not written for a line item, then the curve for the same day of week from the previous week can be used instead. If that is not found either, the network default (e.g., mid-flight or last-day as applicable) can be applied. The above process has several advantages: application runs in a standalone container; ability to use the latest versions of libraries, such as Python and Python libraries; simplified build and release process. In one embodiment, the vertica updates can also be batched which leads to improved performance. In one or more embodiments, the above-process can be executed multiple times a day. In one embodiment, to retrieve hourly weights that pertain to a given line item, a GET command can be executed on the budget pacing webserver.

FIG. 2C shows a graphical representation 230 of pacing weight over the hours of a day for a line item historical delivery and for an account-level average. FIG. 2D shows a graphical representation 231 of real-time guaranteed line item pacing implemented by forecasting, which gives pacing precision and yield increase or maximization on an impression-by-impression basis. As can be seen in Day 3, because the delivery is behind the pacing curve, the pCPM is maxed out or otherwise at an increased value which blocks out the high CPM RTB bids, that come in, from obtaining ad delivery. As can be seen in Day 5 and 6 where forecast-shaped pacing is implemented, the pCPM is maintained at lower and stable values which do not block out the high CPM RTB bids, that come in, from obtaining ad delivery and which is indicative of the efficiency of the process. FIG. 2D exemplifies intra-day pacing. The forecast-shaped pacing can allocate a line item's hourly delivery goals according to the specific inventory forecast of that guaranteed line item. This can result in increased yield from RTB bids. Increased pacing accuracy of guaranteed line items can allow the publisher to take advantage of high CPMs from RTB bids throughout all hours of the day. This process can also provide for better delivery throughout the entire day. For example, better pacing can be achieved by leveraging the forecast rather than historical line item delivery or a universal shape supply shape.

As described herein, selection of a guaranteed line item rather than selecting a non-guaranteed line item (e.g., an RTB offering a higher yield) can be based on a number of factors including pCPM and pacing weights. For instance, a pCPM calculation can be based on a bidding history in bid landscape logs. The pacing weights (e.g., for a guaranteed line item selection between competing lines) can be based on various factors including budget, forecasted capacity and/or current fill.

Various methods can be utilized to calculate the pCPM value that can be used for a guaranteed line item selection algorithm. As a first example, a hive table logs all the bids for an auction but with caveats: data is sampled at different rates (ranging from 1% to 50%) by member and sampling is done by user_id, not auction_id. There may be no granularity below member_id. Data may not be available for all members. This log allows identifying guaranteed vs non-guaranteed bids, so one can calculate the distribution of non-guaranteed bids among winning bids or all bids in auctions that have at least one guaranteed bid. For instance, one can calculate the 90th, 95th, 99th percentile of the non-guaranteed bid (among winning or all bids) in auctions with at least one guaranteed bid and use that as the pCPM value. In one embodiment, if the bid landscape data is available for a member: the 99th percentile of the winning non-guaranteed bid can be used as the pCPM value; else use the value of 20.

In another embodiment, another table can be used that has all the bids in an auction and is not sampled. However, this technique also has caveats. Bid data may be available only for a top number of members (e.g., 100) on the platform. It may not be possible, at least in some instances, to distinguish guaranteed vs non-guaranteed bids. This table does allow one to go down to the granularity of publisher level, but only a limited number of members with guaranteed line items may have bid-level data in this table. One can calculate a specified percentile (e.g., 90, 95, 99) of a maximum bid price or a winning bid price by member and can use that as the pCPM.

Various techniques or algorithms can be employed for selection between eligible lines such as a guaranteed line item selection. In one or more embodiments, a line item is considered eligible for a given auction if the line item has budget remaining, and the submitted buyer bid is below the computed pCPM. Eligible lines can then be selected based on the following weight algorithms:

$$Linear \text{:} w ( i ) = \frac{CPM ( i )}{Σ pCPM ( i )}$$

$$Quadratic \text{:} w ( i ) = \frac{{pCPM ( i )}^{2}}{Σ {pCPM ( i )}^{2}}$$

$$Cubic \text{:} w ( i ) = \frac{{pCPM ( i )}^{3}}{Σ {pCPM ( i )}^{3}}$$

The above algorithms are only pCPM-based. However, other algorithms can also be utilized. For example, algorithms that take into account budget remaining can be utilized which may avoid under-delivery for line items having lower budgets. For instance, the algorithm can use a ratio of pCPM/(budget_remaining). Other algorithms can be employed that utilize these factors including powers and logs of these variables.

In one or more embodiments, other algorithms can be determined based on simulations. For instance, a dataset used for a simulation can be a full-day (24 hour) of data across all auctions such as for a single publisher from an impression log. For instance, a dataset of two to three million samples can be utilized based on publishers who had hourly impressions less than 100,000. Various fields can be extracted from the impression log for all hours of the particular day such as user_id, auction_id, date time, buyer_bid, imp type, publisher_id, tag_id, seller_revenue.

The simulations can have adjustable parameters including: (1) number of guaranteed lines: this parameter can vary such as between 2 to 5, to balance generating sufficient dynamics, making it closer to real-word as well as computation time; (2) fill rate: this is the ratio of budget/supply which can allow for broadly categorizing lines based on their ease of delivering fully based on their fill rate, such as Fill Rate ˜0.1 (easy), ˜0.5 (medium), 0.9 (hard); (3) targeting: one can simulate a guaranteed line item based on a simple campaign targeting rule—for instance, the targeting can be based simply on a tag id where tags are chosen from a top number of tags (e.g., 5) by the number of auctions.

As part of the simulation, there can be overlap between the targeting for the various campaigns. In one embodiment, simulation can be based on non-overlapping campaigns. For instance, the overlap can be quantified (e.g., using an intersection/union metric). In this example, the overlap along with the fill_rate can determine the actual delivery.

In one embodiment for the simulation, the supply shape can be the default network supply curve described above. In another embodiment, some variation can be added between the supply shapes for the simulated line items, such as picking from a random sample of actual guaranteed line items (or actual programmatic guaranteed if capacity forecasts have already been generated for them) to fine-tune the simulation. In addition to using just pCPM and budget_remaining for the line selection algorithm, other factors can include one or more of: fill_rate (which can be an input to the simulation), budget_remaining/budget_goal, target_delivery_rate=budget_remaining/time_remaining. For example, these algorithms can use weights based on functions as follows: pCPM/log (budget_remaining); pCPM*fill_rate\hat{ }3; pCPM*fill_rate\hat{ }3/budget_remaining; pCPM*fill_rate\hat{ }3/log(budget_remaining); pCPM*fill_rate\hat{ }3/(budget_remaining/budget_goal); pCPM*fill_rate/tdr; pCPM*fill_rate\hat{ }3/tdr.

In other embodiments, algorithms can be implemented where the pCPM is uncapped (instead of having it fixed such as at 20) or setting it to the 95th or 99th percentile of the buyer bid.

In one or more embodiments, including the fill_rate in the algorithm can facilitate meeting delivery goals (e.g., at high fill rates). For example, fill_rate can be defined as the line's budget/forecasted capacity. In one embodiment, the API can be modified so that the controller can pass in the capacity so that the controller can calculate the fill rate. In one embodiment, to pass in the capacity, the normalized curve times capacity can be provided to the controller and the controller can extract the capacity and normalized curve from it. In one or more embodiments, the line item selection algorithms can include using weight pCPM/budget_remaining, if fill_rate is <0.5 and using weight pCPM*fill_rate\hat{ }3/budget_remaining, if fill_rate is >0.5.

Various data flows can be employed to provide for management of electronic advertising in accordance with various aspects described herein. Various devices and combinations of devices can be utilized to implement the data flow which can be used in conjunction with various systems described herein such as system 100 of FIG. 1. Exemplary data flows and devices, as well as other ad management techniques which can be used with one or more of the embodiments described herein are described in U.S. application Ser. No. 16/717,243 filed Dec. 17, 2019 and entitled “Method and Apparatus for Managing Brokered Curated Deals in Electronic Advertising”, the disclosure of which is hereby incorporated by reference herein. For example, an ad delivery and decisioning system can be employed which can be a server or a server cluster that processes various transmissions and data associated with electronic advertising including one or more of processing ad requests, providing data to members, conducting auction(s), returning ads or creatives to the publishers and/or to end user devices, maintaining and monitoring information to track billing and/or usage, returning auction-result data, and/or enforcing policies such as quality standards. As an example, the ad delivery and decisioning system. can allow participants to interface and interact.

In one or more embodiments, the data flow can be part of a Server-Side Ad Insertion (SSAI) platform and/or a Client-Side Ad Insertion platform (CSAI). In one embodiment, a proprietary bidder can evaluate eligible managed seller's line items and can accumulates bids. This process can include the proprietary bidder accessing seller's line items that have been generated by a seller (e.g., the seller associated with the ad space of the add call). For example, sellers can create seller's line items through a user interface provided by the proprietary bidder or via another technique or component. Seller's line items allow users to manage direct sales via the line items. The seller's line items can include various parameters, such as one or more of pricing, budgeting, pacing, key value parameters, target viewing rate, targeting information, particular buyer. In one or more embodiments, the seller's line items can be based on arrangements or agreements made by the seller with the buyer. The proprietary bidder can discover seller's line items that are a match for the ad call, such as based on one or more of the parameters included in the creative line item (e.g., pricing, budgeting, pacing, key value parameters, target viewing rate, targeting information).

In one or more embodiments, a curated deal process can enable auctions that are performed in phases or performed in a segmented fashion across the platform. For instance, inventory aggregation deals can be discovered where the curated deals target seller inventory available on the exchange without any agreement between broker and seller (e.g., specified inventory targeted in a same way that any bidder user would target the seller inventory (such as by domain name) such that the seller does not need to take explicit action to be included).

In one embodiment, an ad delivery and decisioning system can send deal and/or RTB bid requests to all of the discovered eligible bidders, such as through a proprietary bidder and/or to other bidder platforms (e.g., one or more other open exchanges that may be operated by entities different from the entity operating the ad delivery and decisioning system).

In one or more embodiments, an ad delivery and decisioning system can analyze the deal and/or RTB bids that have been received to validate, rank (e.g., by priority and/or price), implement pacing and/or apply curation fees. This analysis can result in a determination of a winning bid. Various techniques can be applied to determine the winning bid including prioritizing particular buyers due to preferential access agreements, price comparisons, pacing and so forth.

In one or more embodiments, pre-bidding can be implemented (e.g., via a prebid server or by other devices including end user devices) in which communication is established with one or more SSPs or demand partners, such as advertising networks or exchanges. This can enable a seller such as a publisher to have auctions (e.g., simultaneously or overlapping in time) with all or selected SSPs (including ad exchanges). in this manner, sellers or publishers can receive bids on inventory that may be unavailable through a primary ad server and exchange. In one embodiment, the returned bids or a portion thereof can be provided to an ad server or other managing server to compete with direct demand and the primary ad server's exchange. In one or more embodiments, the prebid auctions can be performed in a particular time frame such as within a few hundred milliseconds (e.g. less than 100 or 200 milliseconds), although, other time frames can be utilized by the exemplary embodiments.

In one or more embodiments, data and performance information can be provided to various parties including buyers, sellers and/or brokers, such as through a user interface of the proprietary bidder and/or the ad delivery and decisioning system.

In one or more embodiments, curated deals can be used in conjunction with various other techniques for managing electronic advertising including CSAI and/or SSAI implementations of prebidding and including ad insertion into various types of content including web sites, video games, long form video, video-on-demand, connected TV, ad pods in video streams, and so forth. For example, winning bids can be determined from analysis of curated deals where a broker aggregates multiple seller inventory and where one or more components or techniques for implementing auctions, ad insertion, business rule enforcement, yield policy enforcement, competitive separation enforcement, and so forth are utilized as described in U.S. patent application Ser. No. 16/560,666 filed Sep. 4, 2019 and entitled Content Management in Over-The-Top Services, the disclosure of which is hereby incorporated by reference herein in its entirety.

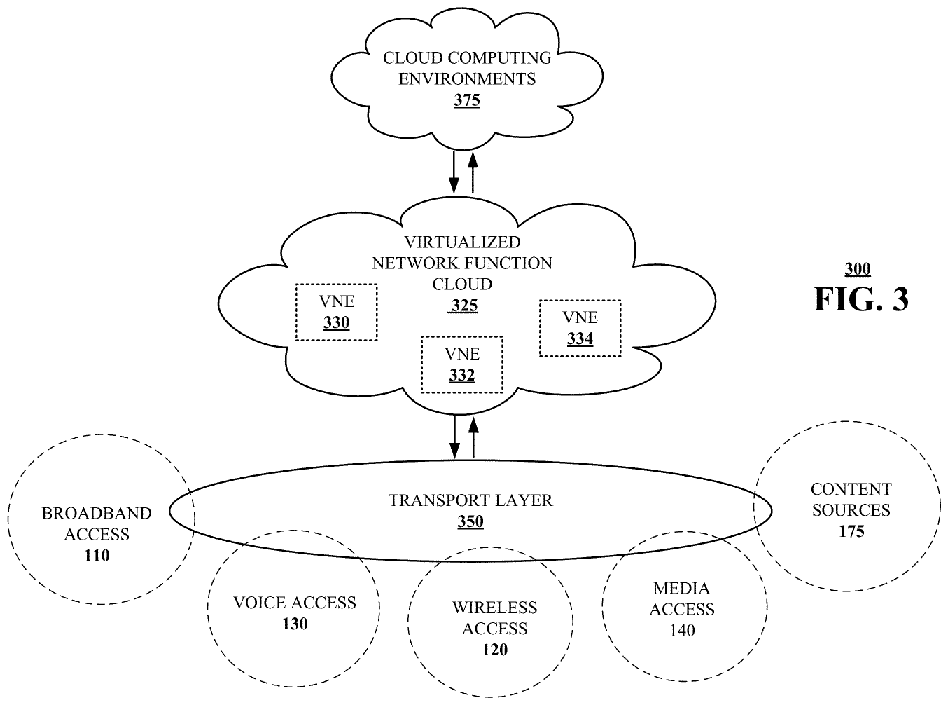

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of communication network 100, the subsystems and functions of system 240 and method 280 presented in FIGS. 1, 2A and 2B. For example, virtualized communication network 300 can facilitate in whole or in part (alone or in conjunction with auctions and/or deal auctions), applying forecast-shaped pacing in ad delivery. For instance, ad space opportunities can be determined in one or more inventory types (e.g., website display, website video, VOD, OTT video, addressable TV, DDL TV, and so forth) for particular targets (e.g., audience having particular characteristic(s) and/or trait(s)). In one or more embodiments, the forecasting can be utilized for pacing with respect to guaranteed line items so that the guaranteed delivery requirements can be fulfilled, while also allowing for yield improvement, such as delivering ad spaces to line items having higher bids (e.g., from programmatic or real-time bidding) for the particular ad spaces.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

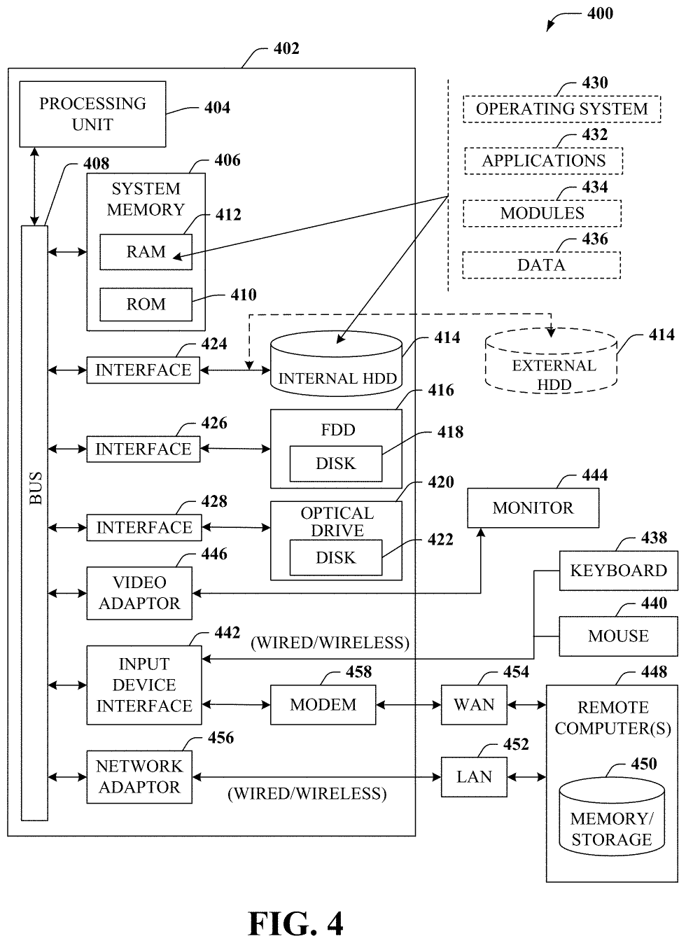

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part (alone or in conjunction with auctions and/or deal auctions), applying forecast-shaped pacing in ad delivery. For instance, ad space opportunities can be determined in one or more inventory types (e.g., website display, website video, VOD, OTT video, addressable TV, DDL TV, and so forth) for particular targets (e.g., audience having particular characteristic(s) and/or trait(s)). In one or more embodiments, the forecasting can be utilized for pacing with respect to guaranteed line items so that the guaranteed delivery requirements can be fulfilled, while also allowing for yield improvement, such as delivering ad spaces to line items having higher bids (e.g., from programmatic or real-time bidding) for the particular ad spaces.

As another example, computing environment 400 can: receive an ad call associated with an ad space available in media content that is being presented at an end user device; identify a group of bidders based on an analysis of line items that include a curation deal line item; conduct auctions with the group of bidders, where the auctions include a curated deal auction based on a curated deal of the curation deal line item in which a broker aggregates curated deal inventory across a plurality of sellers including a seller of the ad space, and where the curated deal inventory includes the ad space; obtain bids from the auctions; determine a winning bid from among the bids; and provide a notification associated with the winning bid, where the notification causes the end user device to render a creative associated with the winning bid in the ad space. In one embodiment, the line items include seller's line items and seller deals, where the seller's line items are associated with buyers, and where the seller deals are associated with a seller that aggregates deal inventory of the seller including the ad space and offers preferential terms. In one embodiment, the winning bid corresponds to the curation deal line item that has a same buyer as a particular seller deal of the seller deals. In one embodiment, the auctions include a deal auction associated with one or more of the seller deals. In one embodiment, the broker is a third party entity distinct from buyers and the seller, and where the curated deal auction is based on an indication of the seller prior to the curated deal auction that the ad space is to be included in the curated deal inventory. In one embodiment, a call back message can be received responsive to the end user device rendering the creative. In one embodiment, the receiving the ad call comprises receiving deal identification information from a supply-side platform server. In one embodiment, the auctions include a real-time bid auction in which bid requests are transmitted to a plurality of Supply-Side Platform (SSP) servers, and where bid responses are received from one or more of the plurality of SSP servers within a time deadline. In one embodiment, equipment of the broker stores user information associated with a user of the end user device.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM),flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

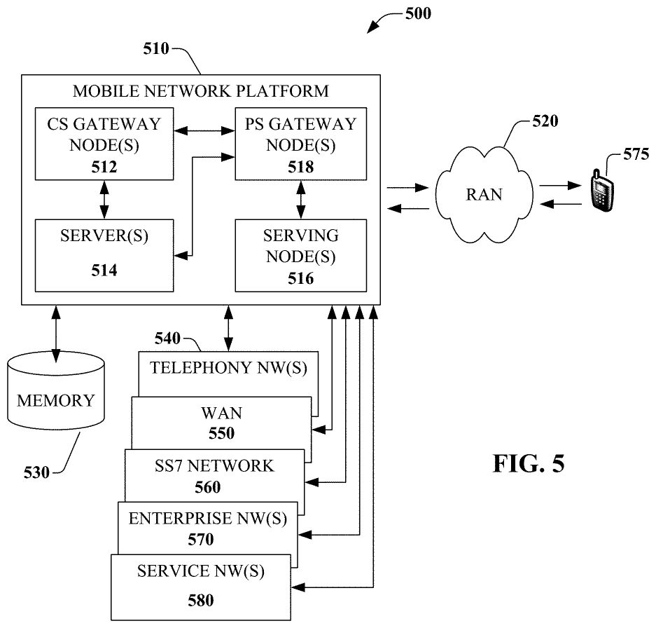

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part (alone or in conjunction with auctions and/or deal auctions), applying forecast-shaped pacing in ad delivery. For instance, ad space opportunities can be determined in one or more inventory types (e.g., website display, website video, VOD, OTT video, addressable TV, DDL TV, and so forth) for particular targets (e.g., audience having particular characteristic(s) and/or trait(s)). In one or more embodiments, the forecasting can be utilized for pacing with respect to guaranteed line items so that the guaranteed delivery requirements can be fulfilled, while also allowing for yield improvement, such as delivering ad spaces to line items having higher bids (e.g., from programmatic or real-time bidding) for the particular ad spaces.

In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

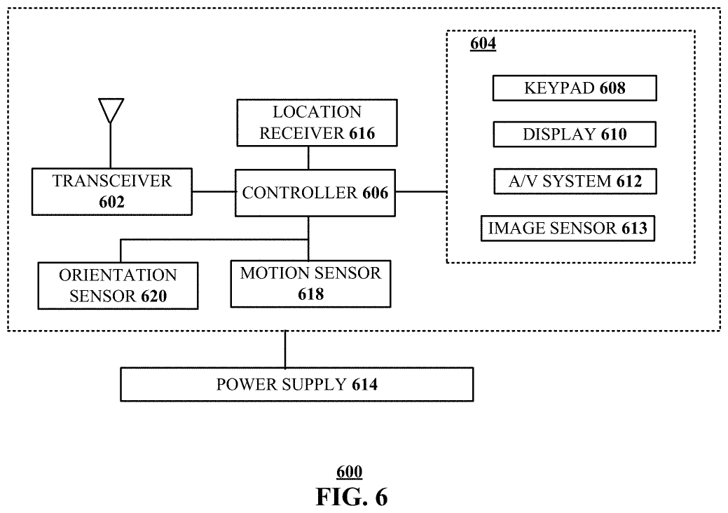

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part (alone or in conjunction with auctions and/or deal auctions), applying forecast-shaped pacing in ad delivery. For instance, ad space opportunities can be determined in one or more inventory types (e.g., website display, website video, VOD, OTT video, addressable TV, DDL TV, and so forth) for particular targets (e.g., audience having particular characteristic(s) and/or trait(s)). In one or more embodiments, the forecasting can be utilized for pacing with respect to guaranteed line items so that the guaranteed delivery requirements can be fulfilled, while also allowing for yield improvement, such as delivering ad spaces to line items having higher bids (e.g., from programmatic or real-time bidding) for the particular ad spaces.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

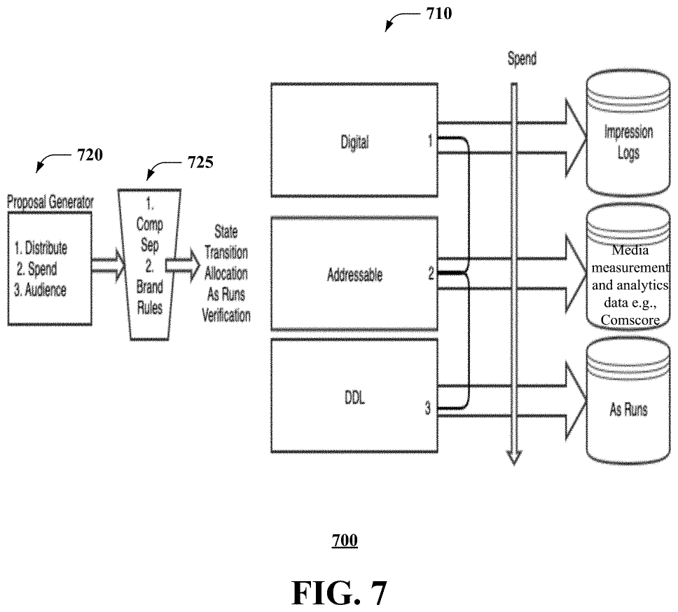

Referring now to FIG. 7, a block diagram is shown illustrating an example, non-limiting embodiment of a system 700 in accordance with various aspects described herein to provide for electronic advertising across various inventory types 710. Various devices and combinations thereof can be utilized to implement the electronic advertising including employing one or more of the functions of the methodology of FIG. 2B and/or combining with various systems described herein such as system 100 of FIG. 1. System 700 enables management of electronic advertising in a number of different ways which can include applying forecast-shaped pacing to various inventory types and can be applied to guaranteed line items.

System 700 allows both characterizing an audience composition of targets and describing how these characterizations may then be used to recommend targets with similar or like audiences. System 700 can create proposed plans 720 for ad placements across all authorized networks included in each flight. For example, placements can be restricted to authorized networks for the buyer and advertiser. In one embodiment, placements can be further restricted to whitelisted networks if specified. In another embodiment, placement distribution among networks can be based on inventory availability such as at the requested budget and/or CPM goals and/or clearance by the network owner. In another embodiment, all ad creative content (e.g., video files) can be available, verified for placement and pass quality control requirements on each included network before proposals will be generated. In another embodiment, the resulting plan can specify a network list and global daypart mix, along with impression and spend estimates. For example, if the default minimum of 50% of the requested budget cannot be met due to inventory or pricing constraints, the order can be deemed infeasible. As another example, if no plan can be generated where the requested daypart mix percentages are maintained within −2.5% of the requested minimum and +2.5% of the requested maximum among at least three networks, the order can be deemed infeasible. If no plan can be generated where the requested CPM goal as expressed or implied by the budget/impressions ratio is maintained within +/−5%, the order can be deemed infeasible. As can be seen in FIG. 7, ad delivery can be across various inventory types 710 including digital, addressable, and/or DDL. In one embodiment, forecast-paced shaping can be utilized in selecting ad delivery across multiple inventory types and frequency capping (including across different devices and types of devices) can further be applied across the multiple inventory types, such as limiting ad delivery to a particular number for a day (or other time period) regardless of the inventory type.

In one or more embodiments, various settings can be customized according to a content provider's needs. In one embodiment, if a prior year's data is not available for a given future month (or quarter) then this can be the default month (or quarter) used. This can be important for content providers that have been implemented within the past year, where there are only a few months of history. For instance, the chosen historic period can be the month (or quarter) that best represents the content provider's average pricing and sell through situation.

In one embodiment, a sell through threshold can be utilized which is the sell through percentage that indicates strong demand for a product. If a sell through is above this threshold, the optimizer can attempt to raise price. In one embodiment, a maximum rate card CPM can be utilized which is the maximum possible rate card CPM value that the optimizer will recommend for any product.

In one embodiment, price elasticity of demand can be utilized. When the optimizer runs, it can simulate the tradeoff between price (ASP) and quantity of demand (Sell Through) for a given product. With this elasticity value set to 1, ASP and Sell Through can trade off such that the product's revenue stays constant (i.e., ASP x modeled Consumed Impressions stays constant). If elasticity is less than 1, an increased price can lead to an increase in revenue and vice versa. If elasticity is greater than 1, an increased price can lead to a decrease in revenue and vice versa.

In one embodiment, high sell through price elasticity of demand can be utilized. If a product's Sell Through is above the Sell Through Threshold, the optimizer can change its demand curve. Typically, this will be lower than the other elasticity value, which represents the fact that if sell through is really high, there is enough demand that advertisers will pay more for the product. In one embodiment, rate card price adjustment or markup can be utilized. If rate card CPM is lower than the optimized ASP, the recommended rate card CPM can be this fixed percentage greater than the new ASP. In one embodiment, floor price discount can be utilized. For example, if rate card CPM is lower than the optimized ASP, the recommended floor CPM can be this fixed percentage lower than the new rate card CPM.

In one embodiment, cross elasticity basis can be utilized which can include a methodology used for identifying similar products or products in the same neighborhood (i.e., substitutes of each other). For example, this can be based on audience affinity or purchase behavior. In one embodiment, using a cross-elasticity basis of audience can be done based on a customer collecting audience affinity data. In one embodiment, cross elasticity threshold can be utilized. For example, if the methodology is purchase behavior, then this is the minimum number of orders that should have the same two products appear on them before those products are in the same neighborhood. In one embodiment, affinity threshold can be utilized, which can be a minimum affinity score that two products should have before they are deemed in the same neighborhood. In one embodiment, maximum neighborhood size can be utilized which is the maximum number of other products that are in a given product's neighborhood. In one embodiment, use allocator can be utilized, which determines whether the allocator is used in the optimization analysis. In one embodiment, maximum time can be utilized, which is the amount of time the optimization process will run before stopping. In one embodiment, attribute classification can be utilized. For example, to characterize the compositional makeup of targets, the classification of attribute types can be performed, in addition to or in place of treating all attributes symmetrically and representing targets as a blend of both structural and compositional targeting criteria. Classification of attributes allow for separating out the attributes used for site structural and/or topographical and/or hierarchal purposes from those used for audience compositional purposes (e.g., gender, geography, behavior, and so forth). For example, the following classifications can be utilized: structural; audience compositional; other. In one embodiment, an administrative user interface can be provided for managing or adjusting classifications.

In one embodiment, audience composition measurement can be utilized. Measuring the audience composition of a target can be facilitated once the classification of attributes is determined. For instance, each known target can maintain a count of the individual audience compositional attribute term values by day. A prototype week can be developed to include these audience compositional counts and a target accrual index used in dynamic product lookups. This allows the system to produce user-facing metrics (e.g., absolute quantity or ratio based) allowing an analyst to visualize and understand the audience that comprises a given target, as well as the system to quantify (e.g., ratio based) cross-elasticity and produce viable recommendations based on the similarity of a product. For example, the following metrics can be utilized per target for the audience compositional attribute term values: absolute count of attribute—term value by day; and/or ratio of attribute term value to target total impressions (compositional ratio).

In one embodiment, recommendations can be made using audience composition. For example, the audience similarity-based recommendations can be made using the compositional ratios. A target's compositional makeup may be characterized by the dominating (over 50%) (top n) compositional attribute term values. For instance, like targets may be determined by comparing the dominating compositional attribute term values to all other targets' in the system compositional ratios. Those with similar ratios may be considered to have audience similarity. In one embodiment, similarity boosting may occur for the number of dominating compositional attribute term values shared in common as well as the absolute relative similarity of ratio of the dominator. As an example, a target having 80% male and 95% auto-intender may be scored vis-a-vis another target having 87% auto-intender and 90% male while neither of the targets may have used auto-intender or gender as targeting criteria and ordered recommendations may occur. Continuing with this example, targets having the most similar compositional makeup can score the highest (e.g., 80% male vs 78% male will score more highly than 80% male vs 95% male) as the audience of the secondary target more closely approximates the ratio of the primary target.

In one embodiment, competitive separation and/or brand rules can be applied at 725. For example, competitive separation can be implemented which can consider delivery restrictions due to advertiser and advertiser group restrictions. For example, competitive separation can exclude competitors' order lines from showing on the same slots or pods or break. In one embodiment, brand rules or guidelines (e.g., “brand standards”, “style guide” or “brand book”) can be enforced or otherwise utilized, which are essentially a set of rules that explain how the brand works. These guidelines can include basic information such as: an overview of brand's history, vision, personality and key values.

In one embodiment, exclusions can be utilized, which allow for buyers to request specific premium inventory by eliminating undesired inventory. For instance, exclusions of specific networks or day parts can be utilized. Ad Delivery logic can be applied in real time such that it prevents line items from being delivered to ad units when the ad manager ad exclusion matches the label. In one embodiment, ad category can be utilized which restricts or allows serving of ads belonging to ad exchange ad categories. In one embodiment, if a user selects this option, the user will not be able to apply other label types. System 700 can utilize impression logs, As Runs, and/or media measurement and analytics data in managing electronic advertising.

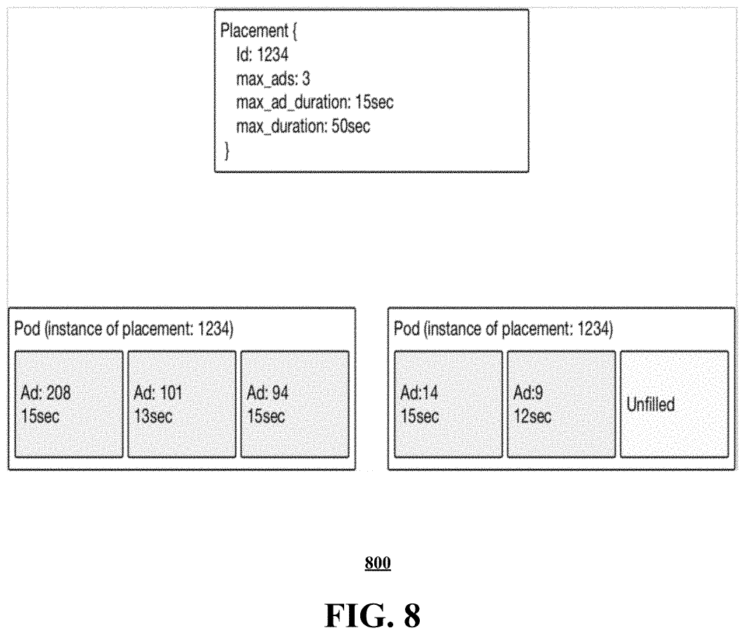

Referring now to FIG. 8, a block diagram is shown illustrating an example, non-limiting embodiment of ad placement 800 in accordance with various aspects described herein to provide for electronic advertising. Various devices and combinations thereof can be utilized to implement the electronic advertising including employing one or more of the functions of the methodology of FIG. 2B and/or combining with various systems described herein such as system 100 of FIG. 1. Ad placement 800 enables management of electronic advertising in a number of different ways which can include applying forecast-shaped pacing to various inventory types and can be applied to guaranteed line items. FIG. 8 illustrates an instance of a placement. It can be a container of ads following the rules specified by its placement. In one embodiment, each allocate event contains offers to be allocated with some AdFormat specific data, this is known as the payload. Each AdFormat (digital or TV (addressable or DDL)) can have a distinct format for its payload. The payload can include the following parts: preamble which describes the contents of the payload; adjustments which are an array of bytesWritables (e.g., the array length can be=num_offers from the preamble); offers which can be an array of offers (e.g., the array length can be=num_offers from the preamble; and targets which can be an array of bytesWritables (e.g., the array length can be=num_offers from the preamble). In one embodiment, there can be a maximum number of elements (e.g., five) in each of the adjustments, offers, and targets array. As an example, arrays can be ordered as follows: intro_bumper, outro_bumper, first_slot_in_pod, last_slot_in_pod, any_slot_in_pod. In one embodiment, it is guaranteed that the last element in, will always be targeted to any_slot_in_pod. The presence of intro_bumper and outro_bumper elements can be determined by the preamble. TV_flags, the presences of first_slot_in_pod and lost_slot_in_pod can be determined by the targeting on the placement.

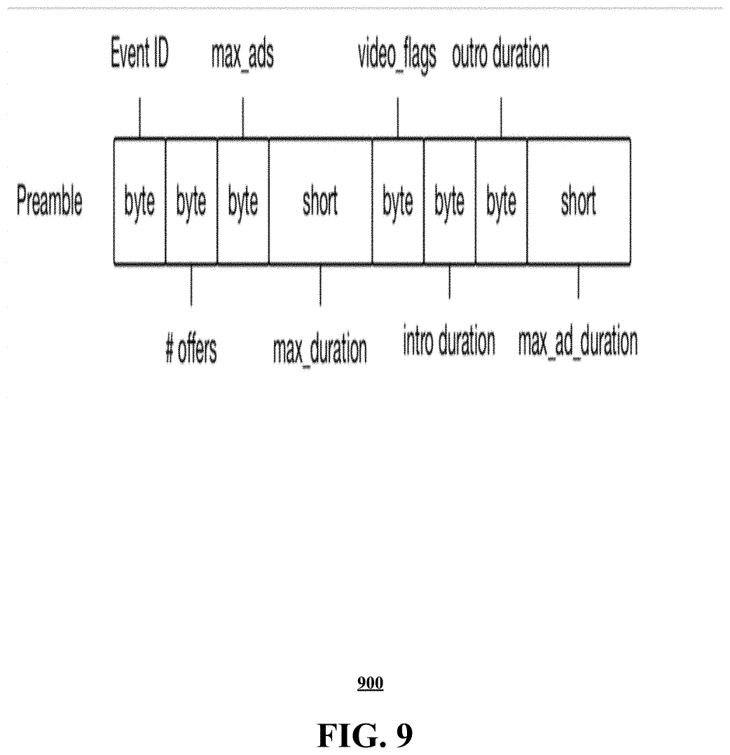

Referring now to FIG. 9, a block diagram is shown illustrating an example, non-limiting embodiment of a payload preamble 900 in accordance with various aspects described herein to provide for electronic advertising across various inventory types. Various devices and combinations thereof can be utilized to implement the electronic advertising including employing one or more of the functions of the methodology of FIG. 2B and/or combining with various systems described herein such as system 100 of FIG. 1. Each payload can begin with the preamble 900 which describes the contents of the payload. The preamble can include the following fields: event ID which is the ID of the event (e.g., three for video); number of offers which is the number of offers in the payload (e.g., this can be different from maximum ads); maximum ads which can be the maximum number of ads which can serve in these slots or pods; maximum duration which is the maximum duration of these slots or pods in seconds; flags which indicate which optional fields are present in the preamble; intro duration which specifies the intro bumper duration in seconds (e.g., this can be an optional field that requires intro_bumper flag to be set in video_flags); outro duration which specifies the outro_bumper duration in seconds (e.g., this can be an optional field which requires outro_bumper flag to be set in video_flags; maximum ad duration which specifies the maximum duration for any ad in these slots or pods in seconds (e.g., this can be an optional field which requires max_duration flag to be set in video_flags.

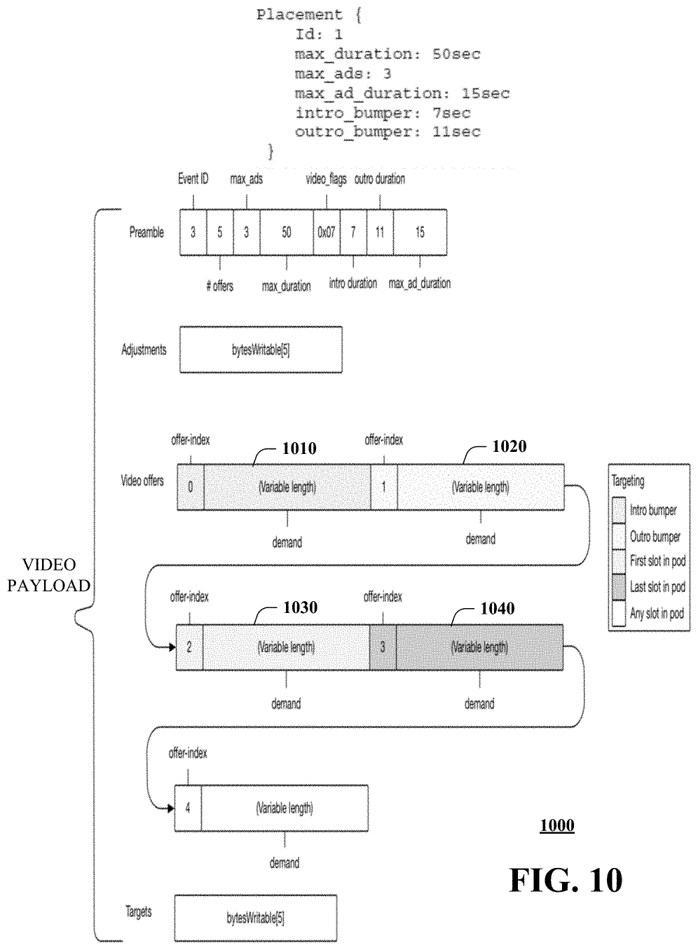

Referring now to FIG. 10, a block diagram is shown illustrating an example, non-limiting embodiment of a video payload 1000 in accordance with various aspects described herein to provide for electronic advertising across various inventory types. Various devices and combinations thereof can be utilized to implement the electronic advertising including employing one or more of the functions of the methodology of FIG. 2B and/or combining with various systems described herein such as system 100 of FIG. 1. Video payload 1000 includes an intro bumper 1010, an outro bumper 1020, a first slot in pod 1030, and a last slot in pod 1040. In one embodiment, max_duration_secs, max_num_ads, and max_ad_duration fields do not apply for bumpers. In one embodiment, each slot can have a fixed amount of time available (max_slot_duration) which can be set for each offer prior to allocation. In one embodiment, slot_duration=the duration of the ad allocated to the slot. In one embodiment, available_time=max_duration−sum(slot_duration). In one embodiment, max_slot_duration=min(available_time, max_ad_duration). In one embodiment, if max_ad_duration is not set in the preamble, max_duration can be used. In one embodiment, if the maximum number of ads is not defined, then it can be calculated using maximum slots or pods duration and minimum reasonable ad duration (e.g., 15 sec). In one embodiment, max_ads=floor(max_duration/15 sec). In one embodiment, each offer (which represents a slot in slots or pods) can be consumed by a single order line. This embodiment can differ from SSA-display which allows multiple order lines to consume against a single offer. In one embodiment, TV-offers can consume impressions in the same manner as display-offers do, which allows for TV and digital campaigns to be attached to the same line item or insertion order, consuming against a shared goal and which allows for adjustments to be applied in the same manner as display-offers.

Each display-offer can typically represent a single impression, which then can have an adjustment factor applied prior to allocation, where the adjustment factor does not need to be a whole number, and which allows an order line to consume fractions of an impression. A difference between display-offers and TV (e.g., Addressable and DDL) offers is that the capacity (in impressions) is not known ahead of time such that slots or pods could be consumed by one 30 second ad, or two 15 second ads. In the first scenario, the slots or pods yields a single impression, in the second scenario two impressions. In one embodiment, impressions only can be adjusted. As an example, the adjustment factor of 1.6 can be applied to slots or pods, each slot in the slots or pods represents 1.6 impressions. One 30 second ad would yield 1.6 impressions, two 15 second ads would yield 2×1.6 impressions. After OLTI's are generated this can be rounded to the nearest whole number of impressions. In one embodiment, TV (Addressable and DDL) allocation can allow for multiple order lines to consume an offer with a restriction that all order lines consuming an offer have the same duration. In one embodiment, duration can be treated as an additional target, one which changes during allocation. For example, prior to any order line consuming an offer, the duration targeting can be thought of as <=max_duration. Once an order line consumes part of an offer, the duration targeting changes from <=max_duration to ==order_line_duration.

An example is as follows: prior to allocation—the offer has a max_duration of 50 seconds and capacity of 1.6 impressions. Any order line with a duration of 50 seconds or less can consume the offer. If an OrderLine (14 second duration) consumes 1.3 impressions then after consumption the OrderLine did not consume the entire offer. The max_duration is now 14 seconds (to match the OrderLine) and duration_condition is exact. The offer can be consumed by 14 second order lines only. In one embodiment, order lines can be sorted by duration, then id, such that implementing the exact condition would involve moving 2 array indices in the order line selectors.

In one embodiment, the duration of an offer may not be known until allocation time, as the offer duration is determined by max_ad_duration and the remaining slots or pods duration. Each offer also has a list of order lines which can consume it. As an example, a placement can have a max_duration of 50 seconds, with the first and second offers have the same targeting. The first offer can have a duration of 50 seconds allowing any order line with a duration of <=50 seconds to serve. Serving a 30 second order line would leave 20 second in the slots or pods. A limiter based on slots or pods duration and order line duration can be utilized to prevent a 30 second order line from consuming the 20 second slot.

In one embodiment, to horizontally scale SSA, impressions for each day can be partitioned into shards, which allows for multiple allocators to run in parallel with each allocating a portion of the traffic. In this example, as each allocator may only see a portion of the traffic for a day, it would only contribute a portion towards the daily goals for campaigns, line-items and order lines. For instance, if a shard contains 2% of the traffic for a campaign, it should contribute 2% towards the daily goal. Prior to allocation, shard ratios can be calculated per order line per shard. This process is straight forward when allocating display-offers, as the number of impressions are known ahead of time. However, TV (Addressable and DDL) allocation is distinct because the number of impressions are not known ahead of time, as each of the slots or pods can yield a varying number of impressions. In one embodiment, creatives are not permitted to serve more than once per ad slots or pods. In this example, this functionally can apply to all creatives and may not be configurable by clients. In one embodiment, assuming adjustments are applied to the pod (all slots in the pod have the same adjusted capacity) then unadjusted_pod_capacity=1 impression, adjusted_pod_capacity=1 impression*adjustment_factor. If an order line can only serve once per pod, an order line's capacity=adjusted_pod_capacity. If adjustments are applied at the slot level, each slot can potentially yield a different number of impressions, in that case. In one embodiment, max_slot_capacity=max(unadjusted_pod_capacity*slot_adjustment_factor). In one embodiment, order_line_capacity=max_slot_capacity. This allows for capacities and shard ratios to be calculated ahead of time.

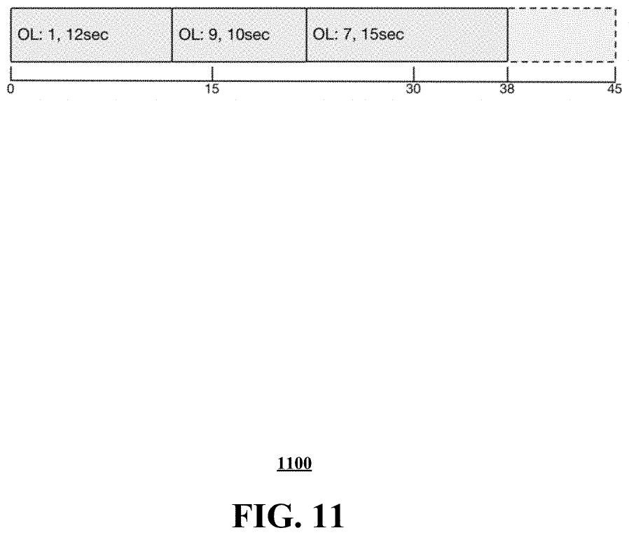

Referring now to FIG. 11, a block diagram 1100 is shown illustrating an example, non-limiting embodiment associated with unfilled time in accordance with various aspects described herein to provide for electronic advertising across various inventory types. Various devices and combinations thereof can be utilized to implement the electronic advertising including employing one or more of the functions of the methodology of FIG. 2B and/or combining with various systems described herein such as system 100 of FIG. 1. FIG. 11 can represent a placement with max_duration: 45 seconds; max_ad_duration: 20 seconds; and max_ads: 3. In this example, all three slots are filled, and the total slots or pods duration is 38 seconds. The remaining 7 seconds is not deemed unfilled since all three slots were filled. This can be designated as such utilizing separate order lines, such as unusuable-video-5s, unusuable-video-10s, and so forth.

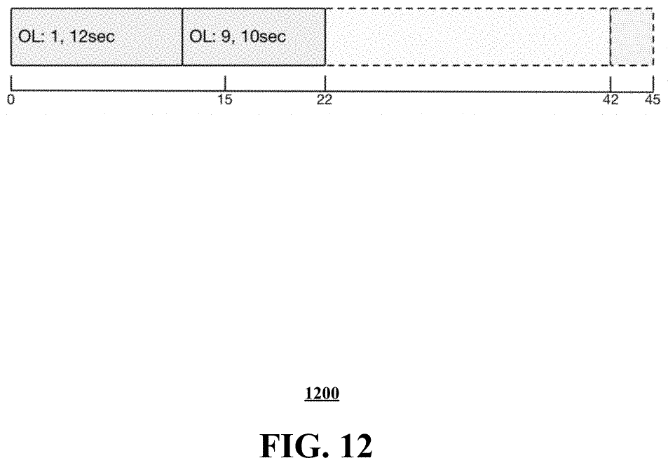

Referring now to FIG. 12, a block diagram 1200 is shown illustrating an example, non-limiting embodiment associated with unfilled time in accordance with various aspects described herein to provide for electronic advertising across various inventory types. Various devices and combinations thereof can be utilized to implement the electronic advertising including employing one or more of the functions of the methodology of FIG. 2B and/or combining with various systems described herein such as system 100 of FIG. 1. FIG. 12 indicates two of the three slots being filled. The total slots or pods duration is 22 seconds. Slots or pods can yield different number of impressions, depending on how it is allocated. Slots or pods could be consumed by one 30 second ad, or two 15 second ads. In the first scenario the slots or pods yields a single impression, in the second scenario two impressions. More generally, in the first case it yields one 30 second impression, in the second case it yields two 15 second impressions.

In one or more embodiments, unfilled time can be expressed in terms of impressions. For example, multiple unfilled order lines of different length (e.g., an unfilled-video-15s, unfilled-video-30s) can be utilized. In this example, two impressions are attributed to unfilled-video-15s, one impression is attributed to unfilled-video-30s. In one embodiment, unusable video is recorded as unfilled-video-5s-with-0-slots.

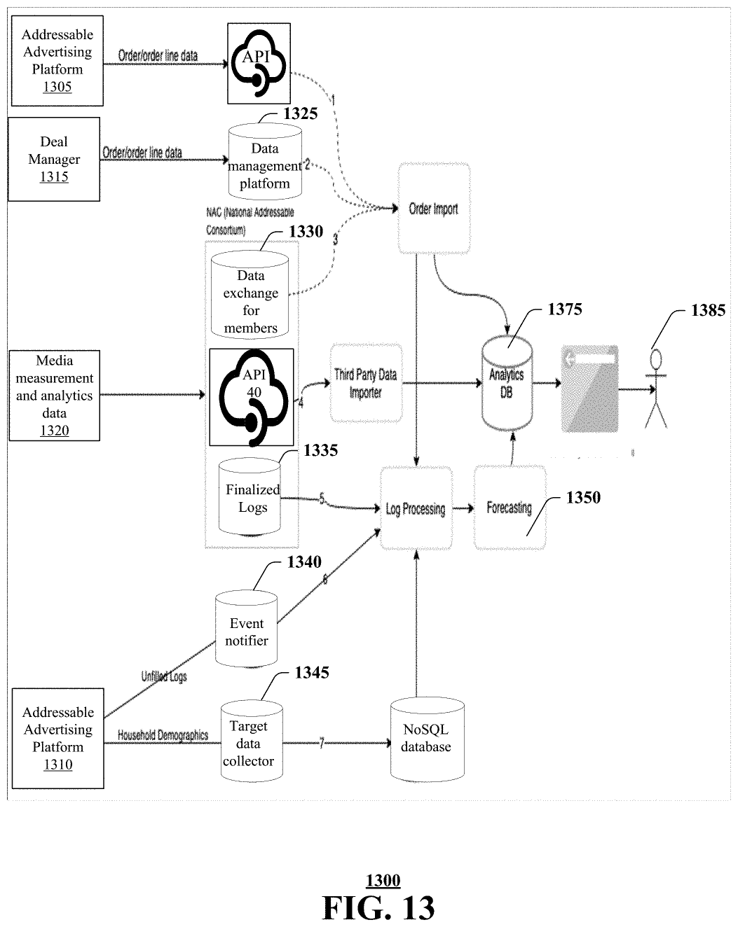

Referring now to FIG. 13, a block diagram is shown illustrating an example, non-limiting embodiment of a system 1300 in accordance with various aspects described herein to provide for electronic advertising across various inventory types for users or customers 1385. Various devices and combinations thereof can be utilized to implement the electronic advertising including employing one or more of the functions of the methodology of FIG. 2B and/or combining with various systems described herein such as system 100 of FIG. 1. Data feeds can be obtained from various sources. For example, the flow in system 1300 can include: (1) addressable advertising platform (e.g., INVIDI) ad-server API 1305 that provides order/order line metadata; (2) deal manager report 1315 originally generated for data management platform 1325 (e.g., Decentrix) that contains order/order line data; (3) Data exchange for members 1330 where ad-server provides a file with order/order line data uploaded such as into an S3 bucket; (4) API40 which is an API that provides daily non-finalized impressions per order line; (5) Media measurement and analytics data 1320 can be gathered by a collector (e.g., Comscore) and provided via finalized logs 1335 which provide finalized impression count per household and order line (which can be a number of days behind); (6) event notifier 1340 can provide Success and Warning events such as from set-top boxes allowing for obtaining unfilled logs for capacity forecasting (e.g., from addressable advertising platform 1310); and (7) target data collector 1345 can provide household demographic data for targeting (e.g., from addressable advertising platform 1310), which may be used in conjunction with an NoSQL database. Order importing, third party data importing, log processing can be performed as in system 1300 leading to forecasting 1350 that is can be utilized as described herein in conjunction with information stored in the analytics database 1375

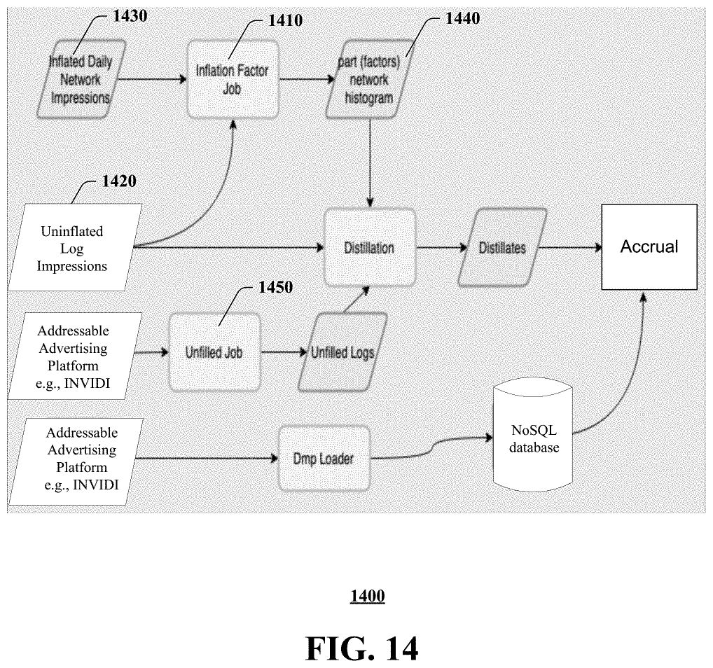

Referring now to FIG. 14, a block diagram is shown illustrating an example, non-limiting embodiment of a process 1400 in accordance with various aspects described herein to provide for electronic advertising across various inventory types. Various devices and combinations thereof can be utilized to implement the electronic advertising including employing one or more of the functions of the methodology of FIG. 2B and/or combining with various systems described herein such as system 100 of FIG. 1. Process 1400 can include log processing, such as for TV service provider logs. In one embodiment, an inflation job factor 1410 sums the total uninflated impressions 1420 at a given day/hour/network/orderlineId. It subsequently calculates the sum of inflated impressions 1430 generated for a given day/hour/network/orderline and divides it against the first sum to come up with the inflation factor for each day/hour/network/orderline. The inflation factor job can generate a network file which contains a list of indexed network names that had impressions on a given log date; a histogram file which contains a table of how many users saw a given number of impressions; and a part file which contains the inflation factor for a given hour/day/networkIndex/orderline 1440. In one embodiment, an unfilled job 1450 filters out warning messages that represent events where an ad was not served due to addressable matching or errors in the set-top box. It also deflates the events based on the tv-off algorithm (e.g., Comscore algorithm). In one embodiment, the network file can be used to decode the part file by translating the networkIndex to a network name so that it can be matched against the network name in the log file (e.g., Comscore log file). In one embodiment, the histogram file can be used to create random user ids for the inflated delta. For example, if a log has 3 uninflated impressions with an associated inflation factor of 0.3, then the 1 impression delta will not be added to the existing user but to a random userId from the histogram. The random userId picked up from the histogram file can be used for each subsequent log line until all its viewable impression capacity has been consumed then a new random user id can be generated and removed from the histogram file. The process can utilize a Dmp loader and the NoSQL database.

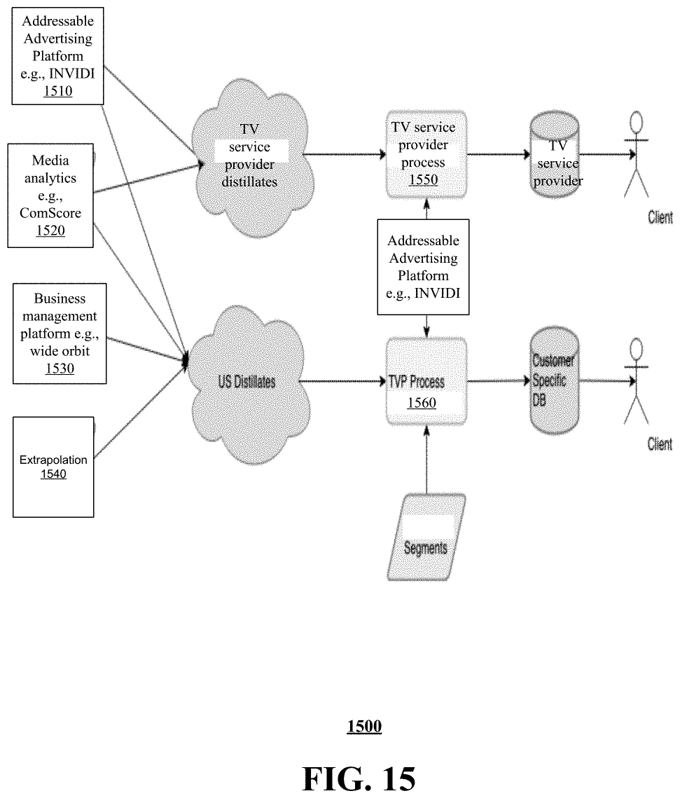

Referring now to FIG. 15, a block diagram is shown illustrating an example, non-limiting embodiment of a system 1500 in accordance with various aspects described herein to provide for electronic advertising across various inventory types. The system 1500 can utilize various sources for information including addressable advertising platform(s) 1510 (e.g., INVIDI), media analytics 1520 (e.g., ComScore), business management platform(s) 1530 (e.g., wide orbit) and/or extrapolation 1540. Various devices and combinations thereof can be utilized to implement the electronic advertising including employing one or more of the functions of the methodology of FIG. 2B and/or combining with various systems described herein such as system 100 of FIG. 1. In one embodiment, the TVP data can be obtained from a storage as well as from API endpoints. The data from the storage can be ingested by the forecast team and stored (e.g., in QFS) for later processing by TV service provider processes 1550 as well as TVP processes 1560. After the data is processed, it can be stored (e.g., in Hadoop Distributed File System (HDFS), MySQL database and NoSQL database (e.g., Aerospike)) and the result of this process (e.g., the forecast) can be made available for look up by the customer via the application UI. TVP clients can consume a slice of the US Distillates where that slice represents the networks that the customer owns. In one embodiment, TV service provider distillates and US Distillates can be stored (e.g., in QFS) and owned by the TV service user. The US Distillates can be shared to TVP clients.

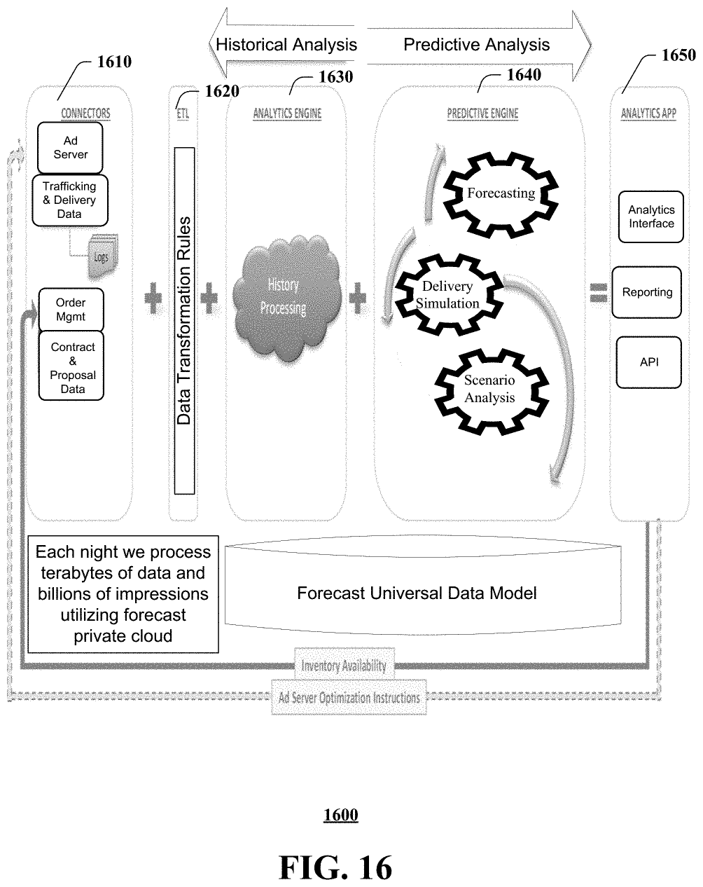

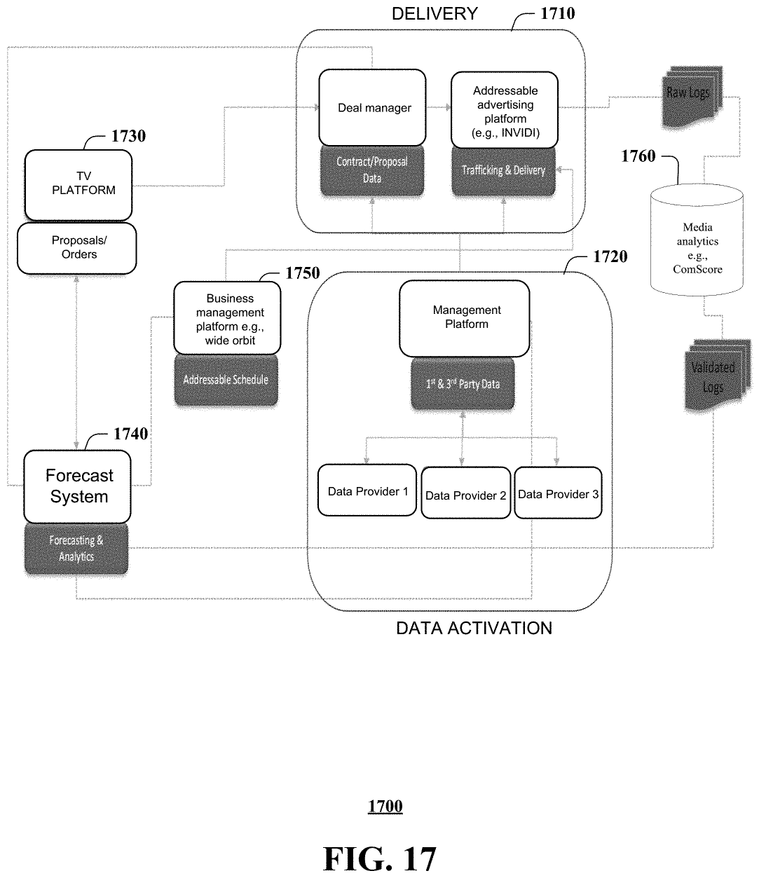

Referring now to FIGS. 16-17, block diagrams are shown illustrating example, non-limiting embodiments of systems 1600 and 1700 in accordance with various aspects described herein to provide for electronic advertising across various inventory types. Various devices and combinations thereof can be utilized to implement the electronic advertising including employing one or more of the functions of the methodology of FIG. 2B and/or combining with various systems described herein such as system 100 of FIG. 1. In one embodiment, converged inventory optimization can be implemented which supports holistic inventory management across all inventory types in order to help planners organize the inventory and understand the optimal way to sell it. System 1600 can perform historical analysis and predictive analysis through use of connectors 1610, data transformation engine 1620, analytics engine 1630, predictive engine 1640, and analytic application 1650. System 1700 can provide for advertising delivery management which includes forecasting based on implementation of delivery system 1710 and data activation system 1720 that are operated in conjunction with and/or in communication with TV platform(s) 1730, forecast system 1740, and business management platform 1750. Other systems can facilitate the functions performed by system 1700 such as media analytics system 1760 which can be provided with access to raw and/or validated logs.

In one embodiment, converged campaign optimization can be implemented based on understanding the overlapping campaigns across all inventory and being able to optimize at a campaign level. This includes competition, risk and value of inventory. In one embodiment, a break schedule can be utilized which provides a description of what can deliver in the future. As an example, the schedule can include number/location of breaks along with the content area. In one embodiment, log files can be utilized which include historical information representing past behavior. As an example, the log files can include actual historical delivery of order lines along with all associated targeting information. In one embodiment, the logs include activities that happened, as well as any information that describes activities that did not happen (e.g., failure, skip, change in schedule, and so forth). In one embodiment, user specific segment, demographic, and/or audience data can be linked back to the activities that happened on the ad server.

In one embodiment, delivery system booking data can be utilized which contains list of order lines that exist on the delivery system along with all targeting parameters that define where the object can deliver. In one embodiment, order management system booking data can be utilized which contains both a list of order lines that: (1) have not been pushed to the delivery system and should be reflected in availability calculations; and (2) have been pushed to the delivery system and includes data not present on that system which can be used for additional reporting needs.

In one embodiment, under-delivery reports can be generated. These reports can be based on captured data from the planner that will help assess at risk revenue based on delivery to date and delivery forecasts. As an example, an export can be a csv file with a date and time stamp indicating when the export was generated. Each row of the export can include summary data for a campaign or an order depending on guarantee type. Campaigns and orders collectively referred to as contracts, can qualify for the export based on two sets of criteria: (1) contracts with finalize weeks: contracts which have a least one line week with finalized delivery, have flight dates extending into at least one or more of the following criteria: actual delivery for the contract is less than 100% of ordered impressions for complete finalized line weeks; forecast delivery for the contract is less than 100%; or forecast delivery for the contract was less than 100% of the previous week; and (2) contracts with no finalized weeks: contracts which have no line weeks with finalized delivery in-flight or have flights beginning in the current or following broadcast week and have contract level forecast delivery is less than 100%.

In one or more embodiments, converged inventory management can be implemented such as for addressable, digital, community. The exemplary embodiments can provide ways to analyze inventory both holistically across inventory types and maintain proper data accuracy. This allows for ad hoc forecast look ups, an ability to investigate inventory across deals, orders and order lines, as well as, reporting capabilities and metrics.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAIVI). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
identifying a first line item having a guaranteed delivery requirement;
determining whether a capacity forecast is available for the first line item and whether a forecasted capacity for the first line item is greater than a capacity threshold;
responsive to the capacity forecast being available for the first line item and the forecasted capacity being greater than the capacity threshold, determining whether the first line item is mid-flight or last-day;
responsive to the first line item being mid-flight, accessing a forecast shape curve for the first line item, wherein generating the forecast shape curve comprises normalizing the forecasted capacity based on weighting for a particular hour being equal to forecasted impressions for the particular hour divided by a sum of forecasted impressions over a day; and
determining whether to sell an ad space in video content, via an electronic ad delivery platform, to the first line item pursuant to the guaranteed delivery requirement or to a second line item pursuant to a real-time bidding process, wherein the determining whether to sell the ad space is based on applying the forecast shape curve on an hourly basis over the day to satisfy hourly delivery goals for the guaranteed delivery requirement of the first line item.

2. The device of claim 1, wherein the forecasted capacity is based on audience targets and not based on advertising products, wherein the applying the forecast shape curve to satisfy the hourly delivery goals includes applying a weight represented by the forecast shape curve to a comparison of a price associated with the first line item to a bid price associated with the second line item.

3. The device of claim 1, wherein the determining whether to sell the ad space is based on at least one of: a bid price associated with the second line item compared to other predicted bid prices at other hours of the day; a priority CPM value that is calculated according to a log of winning non-guaranteed bids; or a combination thereof.

4. The device of claim 1, wherein the operations further comprise:
delivering, via the electronic ad delivery platform, a first impression associated with the guaranteed delivery requirement of the first line item when a current hourly delivery goal has not been satisfied.

5. The device of claim 1, wherein the operations further comprise:
delivering, via the electronic ad delivery platform, a second impression associated with the second line item when a current hourly delivery goal has been satisfied or when a second price for the second line item obtained via the real-time bidding process is higher than a price for the first line item according to the guaranteed delivery requirement.

6. The device of claim 1, wherein the operations further comprise:
determining whether day-parting is utilized by the first line item; and
responsive to the day-parting being utilized on an hourly basis by the first line item, adjusting the forecast shaped curve according to a number of first hours that are not subject to the day-parting and according to when second hours that are subject to the day-parting occur during a day.

7. The device of claim 1, wherein the operations further comprise:
identifying a third line item having a second guaranteed delivery requirement;
determining whether a second capacity forecast is available for the third line item and whether a second forecasted capacity for the third line item is greater than the capacity threshold;
responsive to the second capacity forecast being available for the third line item and the second forecasted capacity being greater than the capacity threshold, determining whether the third line item is mid-flight or last-day;
responsive to the third line item being the last-day, accessing a second forecast shape curve, wherein generating the second forecast shape curve comprises:
generating the second forecast shape curve by normalizing the second forecasted capacity based on weighting for a particular hour being calculated by forecasted impressions for the particular hour divided by a sum of forecasted impressions over a day,
adjusting the second forecast shape curve by increasing weight in a first hour, reducing weights in later hours of the days, and re-normalizing, and
applying an acceleration factor to each non-zero weight, wherein the acceleration factor is based on predetermined values corresponding to different ranges of a ratio of a budget to the second capacity forecast; and
determining whether to sell another ad space, via the electronic ad delivery platform, to the third line item pursuant to the second guaranteed delivery requirement or to a fourth line item pursuant to the real-time bidding process, wherein the determining whether to sell the another ad space is based on applying the second forecast shape curve on the hourly basis over the day to satisfy hourly delivery goals for the second guaranteed delivery requirement of the third line item.

8. The device of claim 7, wherein the generating the second forecast shape curve further comprises adding an additional weight to all hours between a last hour with non-zero weights through to a last hour of the day, and re-normalizing.

9. The device of claim 1, wherein the operations further comprise:
identifying a fifth line item having a third guaranteed delivery requirement;
determining whether a third capacity forecast is available for the fifth line item and whether a third forecasted capacity for the fifth line item is greater than the capacity threshold; and
responsive to the third capacity forecast not being available for the fifth line item or the third forecasted capacity not being greater than the capacity threshold, determining whether to sell another ad space, via the electronic ad delivery platform, to the fifth line item pursuant to the third guaranteed delivery requirement or to a sixth line item pursuant to the real-time bidding process, wherein the determining whether to sell the another ad space is based on applying a first static curve on an hourly basis over the day to satisfy hourly delivery goals for the third guaranteed delivery requirement of the fifth line item.

10. The device of claim 9, wherein the first static curve is determined from historical delivery averages.

11. The device of claim 1, wherein the operations further comprise:
identifying a seventh line item having a fourth guaranteed delivery requirement;
determining whether a fourth capacity forecast is available for the seventh line item and whether a fourth forecasted capacity for the seventh line item is greater than the capacity threshold;
responsive to the fourth capacity forecast not being available for the seventh line item or the fourth forecasted capacity not being greater than the capacity threshold determining whether the seventh line item is mid-flight or last-day; and
responsive to the seventh line item being the last-day, determining whether to sell another ad space, via the electronic ad delivery platform, to the seventh line item pursuant to the fourth guaranteed delivery requirement or to an eight line item pursuant to the real-time bidding process, wherein the determining whether to sell the another ad space is based on applying a second static curve on an hourly basis over the day to satisfy hourly delivery goals for the fourth guaranteed delivery requirement of the seventh line item.

12. The device of claim 11, wherein the second static curve is determined from historical delivery averages.

13. The device of claim 1, wherein the determining whether the capacity forecast is available for the first line item comprises determining whether the capacity forecast covers a 24 hour period for the day.

14. The device of claim 1, wherein the operations further comprise:
delivering, via the electronic ad delivery platform, a first impression associated with the first line item, wherein the ad space of the video content is provided via an over-the-top service.

15. The device of claim 1, wherein the operations further comprise:
delivering, via the electronic ad delivery platform, a first impression associated with the first line item, wherein the ad space of the video content is provided via an addressable television service or a data driven linear television service.

16. The device of claim 1, wherein the first and second line items are associated with a same buyer, and wherein the operations further comprise:
delivering, via the electronic ad delivery platform, a first impression associated with the first line item, wherein the ad space of the video content is provided in a web site.

17. A method, comprising:
identifying, by a processing system including a processor, a first line item having a guaranteed delivery requirement;
determining, by the processing system, whether a capacity forecast is available for the first line item and whether a forecasted capacity for the first line item is greater than a capacity threshold;
responsive to the capacity forecast being available for the first line item and the forecasted capacity being greater than the capacity threshold, accessing, by the processing system, a forecast shape curve for the first line item, wherein generating the forecast shape curve comprises normalizing the forecasted capacity based on weighting for a particular time period of a day being equal to forecasted impressions for the particular time period divided by a sum of forecasted impressions over the day; and
determining, by the processing system, whether to sell an ad space in video content, via an electronic ad delivery platform, to the first line item pursuant to the guaranteed delivery requirement or to a second line item pursuant to a real-time bidding process, wherein the determining whether to sell the ad space is based on applying the forecast shape curve over the day to satisfy delivery goals for the guaranteed delivery requirement of the first line item for each particular time period over the day.

18. The method of claim 17, wherein the forecasted capacity is based on audience targets and not based on advertising products, wherein the particular time period is hourly, wherein the accessing the forecast shape curve for the first line item is responsive to a determination that the first line item is mid-flight, wherein the applying the forecast shape curve to satisfy the hourly delivery goals includes applying a weight represented by the forecast shape curve to a comparison of a price associated with the first line item to a bid price associated with the second line item, wherein the determining whether to sell the ad space is based on the bid price associated with the second line item compared to other predicted bid prices at other hours of the day, and further comprising:
delivering, via the electronic ad delivery platform, a first impression associated with the first line item, wherein the ad space of the video content is provided via one of an over-the-top service, an addressable television service or a data driven linear television service.

19. A non-transitory machine-readable medium, comprising executable instructions that, when executed by a processing system including a processor, facilitate performance of operations, the operations comprising:
generating a capacity forecast for each of a group of line items resulting in a group of capacity forecasts, wherein each of the group of line items includes a guaranteed delivery requirement, wherein each of the group of capacity forecasts are for an active day in a flight of a corresponding one of the group of line items, wherein generating a forecast shape curve comprises normalizing a forecasted capacity based on weighting for a particular time period of the active day being equal to forecasted impressions for the particular time period divided by a sum of forecasted impressions over the active day;
identifying a first line item from the group of line items having a first guaranteed delivery requirement;
determining whether a first forecasted capacity for the first line item is greater than a capacity threshold;
responsive to the first forecasted capacity being greater than the capacity threshold, accessing a first forecast shape curve for the first line item from among the group of capacity forecasts; and
determining whether to sell an ad space of video content, via an electronic ad delivery platform, to the first line item pursuant to the first guaranteed delivery requirement or to a second line item pursuant to a real-time bidding process, wherein the determining whether to sell the ad space is based on applying the particular forecast shape curve over the active day to satisfy delivery goals for the first guaranteed delivery requirement of the first line item for each particular time period over the active day.

20. The non-transitory machine-readable medium of claim 19, wherein the forecasted capacity is based on audience targets and not based on advertising products, wherein the particular time period is hourly, wherein the accessing the forecast shape curve for the first line item is responsive to a determination that the first line item is mid-flight, wherein the applying the forecast shape curve to satisfy the hourly delivery goals includes applying a weight represented by the forecast shape curve to a comparison of a price associated with the first line item to a bid price associated with the second line item, wherein the determining whether to sell the ad space is based on the bid price associated with the second line item compared to other predicted bid prices at other hours of the day, and wherein the operations further comprise:
delivering, via the electronic ad delivery platform, a first impression associated with the first line item, wherein the ad space of the video content is provided via one of an over-the-top service, an addressable television service or a data driven linear television service.
